(19) United States
(12) Patent Application Publication
(10) Pub. No.: US 2024/0241235 A1
(43) Pub. Date: Jul. 18, 2024

(54) LIGHT DETECTING DEVICE AND DISTANCE MEASURING SYSTEM

(71) Applicant: SONY SEMICONDUCTOR SOLUTIONS CORPORATION, KANAGAWA (JP)

(72) Inventors: YUMI YATSUNAMI, KANAGAWA (JP); HIROAKI SAKAGUCHI, KANAGAWA (JP)

(21) Appl. No.: 18/557,230

(22) PCT Filed: Mar. 30, 2022
(86) PCT No.: PCT/JP2022/015947

§ 371 Date: Oct. 25, 2023

(30) Foreign Application Priority Data
May 19, 2021 (JP) 2021-084821

(51) Int. Cl. G01S 7/497; G01S 7/4865; G01S 17/10; G01S 17/894; G01S 17/931

(52) U.S. Cl. CPC G01S 7/497; G01S 7/4865; G01S 17/10; G01S 17/894; G01S 17/931

(57) ABSTRACT

A malfunction diagnosis and malfunction detection can be efficiently performed. A light detecting device including: an array unit configured to have a plurality of light reception areas and have a plurality of light receiving elements disposed inside each of the light reception areas; a calculation unit, for each pixel including one or more light receiving elements included in each of the plurality of light reception areas, configured to generate a histogram relating to the number of times of reception of light in the light receiving element inside the pixel and a light reception timing; and a malfunction detecting unit configured to detect a malfunction of the inside of the calculation unit.

### TECHNICAL FIELD

The present disclosure relates to a light detecting device and a distance measuring system.

### BACKGROUND ART

Automated driving technologies have attracted attention. In the automated driving technologies, it is necessary to measure a distance to an object positioned in the vicinity of a vehicle accurately and quickly. As one method of measuring a distance, a technique of dividing a light reception range of a light receiving element array in which a plurality of light receiving elements are arranged in an array form into a plurality of areas, setting an optimal calculation coefficient for each of the areas, and calculating a distance to an object has been proposed (for example, see PTL 1).

### CITATION LIST

### Patent Literature

[PTL 1]
JP 2020-118567A

### SUMMARY

### Technical Problem

A distance measuring system disclosed in PTL 1 includes a processing circuit for measuring a distance in each of a plurality of areas, and thus the configuration thereof is complicated. Particularly, in order to detect an object positioned in the vicinity of a vehicle with high accuracy, it is necessary to increase the number of light receiving elements included in a light receiving element array. In a case in which the number of light receiving elements included in the light receiving element array increases, from the point of view of increasing the speed of processing, the number of areas acquired by dividing the light reception range needs to be increased. In a case in which the number of areas acquired by dividing the light reception range is increased, the number of processing circuits used for measuring distances is increased.

An in-vehicle device has functional safety to be important and, originally, is preferably include a structure for performing a malfunction diagnosis of each processing circuit disposed inside a distance measuring system. However, in PTL 1 described above, malfunction diagnosis of the distance measuring system is not described.

Thus, according to the present disclosure, a light detecting device and a distance measuring system capable of efficiently performing a malfunction diagnosis and malfunction detection are provided.

### Solution to Problem

In order to solve the problems described above, according to the present disclosure, a light detecting device including: an array unit configured to have a plurality of light reception areas and have a plurality of light receiving elements disposed inside each of the light reception areas; a calculation unit, for each pixel including one or more light receiving elements included in each of the plurality of light reception areas, configured to generate a histogram relating to the number of times of reception of light in the light receiving element inside the pixel and a light reception timing; and a malfunction detecting unit configured to detect a malfunction of the inside of the calculation unit is provided.

The calculation unit may include: a sampling circuit configured to sample output signals of the plurality of light receiving elements included in each of the plurality of light reception areas with a predetermined sampling period and output detection signals indicating that the plurality of light receiving elements have received light for each pixel: an addition circuit configured to generate a pixel value acquired by adding the number of the detection signals for each pixel; and a histogram generating circuit configured to generate the histogram of each pixel in each of the plurality of light reception areas on the basis of the pixel value generated by the addition circuit, and the malfunction detecting unit may detect a malfunction of at least one of the sampling circuit, the addition circuit, and the histogram generating circuit.

The calculation unit may include: a filter circuit configured to eliminate a noise component included in the histogram generated by the histogram generating circuit: an echo detecting circuit configured to measure a distance to an object by detecting a time difference until light is reflected by the object and is received by the array unit after the light is projected on the basis of the histogram after elimination of the noise component using the filter circuit, and the malfunction detecting unit may detect a malfunction of at least one of the sampling circuit, the addition circuit, the histogram generating circuit, the filter circuit, and the echo detecting circuit.

The calculation unit may include a plurality of area calculation units corresponding to each of the plurality of light reception areas, each of the plurality of area calculation units may include at least some circuits among the sampling circuit, the addition circuit, the histogram generating circuit, the filter circuit, and the echo detecting circuit, and the malfunction detecting unit may detect a malfunction of at least some circuits among the sampling circuit, the addition circuit, the histogram generating circuit, the filter circuit, and the echo detecting circuit for each of the plurality of area calculation units.

The malfunction detecting unit may input the same test pattern signal to two area calculation units among the plurality of area calculation units and, in a case in which output signals of the two area calculation units are not the same, determine that any one of the two area calculation units has a malfunction.

The malfunction detecting unit may include: two selectors configured to select whether or not the test pattern signal is to be input to input nodes or internal nodes of the two area calculation units; and a comparator configured to compare output signals of the two area calculation units with each other when the two selectors select input of the test pattern signal.

The malfunction detecting unit may include two encoding units generating encoded data of output signals of the two area calculation units when the two selectors select input of the test pattern signal, and the comparator may compare two pieces of the encoded data generated by the two encoding units.

The calculation unit may include an even number, which is two or more, of the area calculation units, and the malfunction detecting unit may divide the even number of the area calculation units into each set of two area calculation units, input the same test pattern signal to the two area calculation units of each set and, in a case in which output signals of the two area calculation units are not the same, determine that any one of the two area calculation units has a malfunction.

The calculation unit may include an odd number, which is three or more, of the area calculation units, and the malfunction detecting unit may divide the odd number of the area calculation units into a plurality of sets of two area calculation units using some of the area calculation units in a duplexing manner, inputs the same test pattern signal to the two area calculation units of each set and, in a case in which output signals of the two area calculation units are not the same, determine that any one of the two area calculation units has a malfunction.

The calculation unit may include three or more of the plurality of the area calculation units, and the malfunction detecting unit may input the same test pattern signal to the plurality of the area calculation units and, in accordance with whether output signals of some area calculation units among the plurality of the area calculation units are different from output signals of remaining area calculation units that are greater in number than the some area calculation units, determine that the some area calculation units have a malfunction.

Each of the plurality of the area calculation units may have a plurality of stages of processing circuits, which are cascade-connected, including at least some circuits among the sampling circuit, the addition circuit, the histogram generating circuit, the filter circuit, and the echo detecting circuit, and the comparator may include a plurality of comparison units connected to output nodes of the processing circuits of two or more stages that are cascade-connected to a later stage side of the selector for each of the plurality of the area calculation units, and each of the plurality of comparison units may compare output signals of output nodes of the processing circuits of different stages in the two area calculation units with each other.

The calculation unit may have processing circuits of a plurality of stages, which are cascade-connected, including some circuits among the sampling circuit, the addition circuit, the histogram generating circuit, the filter circuit, and the echo detecting circuit, and different selectors may be connected to input sides of two or more processing circuits among the plurality of stages of processing circuits, and the test pattern signal may be selectable using each of the selectors, and the comparator may be disposed in association with each of the selectors on a later stage side of the processing circuit to which each of the selectors is connected.

The number of pixels of the array unit may be larger than the number of pixels for which the calculation unit performs generation of the histogram, the sampling circuit may output the detection signal for each pixel of the array unit, the addition circuit may generate the pixel value of each of pixels of which the number of pixels is smaller than the number of pixels of the array unit, and the selector may be disposed between the sampling circuit and the addition circuit, input a detection signal output from the sampling circuit to the addition circuit with time adjustment at the time of a normal operation, and input the test pattern signal to the addition circuit at the time of a malfunction diagnosis.

The number of pixels of the array unit may be larger than the number of pixels for which the calculation unit performs generation of the histogram, the sampling circuit may output the detection signal for each pixel of the array unit, the addition circuit may generate the pixel value of each of pixels of the array unit, and the histogram generating circuit may generate the histogram of each of pixels of which the number of pixels is smaller than the number of pixels of the array unit, and the selector may be disposed between the addition circuit and the histogram generating circuit, input the pixel value generated by the addition circuit to the histogram generating circuit with time adjustment at the time of a normal operation, and input the test pattern signal to the histogram generating circuit at the time of a malfunction diagnosis.

Each of the plurality of area calculation units may include a calculation coefficient storing unit storing a first calculation coefficient used in a calculation process at the time of a normal operation and a second calculation coefficient used in a calculation process at the time of a malfunction diagnosis, the light detecting device may further include a control unit configured to perform control of selecting one of the first calculation coefficient and the second calculation coefficient and supplying the selected calculation coefficient to the plurality of stages of processing circuits and perform selection switching of the selector.

Each of the plurality of area calculation units may have a first calculation coefficient storing unit storing a first calculation coefficient used in a calculation process at the time of a normal operation, and the light detecting device may further include: a second calculation coefficient storing unit configured to store a second calculation coefficient used in a calculation process at the time of a malfunction diagnosis; and a control unit configured to perform control of supplying the first calculation coefficient to the plurality of stages of processing circuits at the time of the normal operation, perform control of supplying the second calculation coefficient to the plurality of stages of processing circuits at the time of the malfunction diagnosis, and perform selection switching of the selector.

A timing control unit configured to control the array unit and the calculation unit separately in a normal operation period in which the histogram is generated on the basis of light received by the array unit and in a malfunction diagnosis period in which malfunction detection of the calculation unit is performed on the basis of the test pattern signal in a state in which a light reception operation of the array unit is stopped may be included.

A timing control unit configured to perform control of inputting the test pattern signal to an input node or an internal node of the calculation unit and outputting a malfunction diagnosis signal from the calculation unit in a period in which each processing circuit inside the calculation unit performs processing on the basis of light received by the array unit may be included.

A pattern generator configured to generate the test pattern signal including a random pattern of a time series may be included, and the same test pattern signal may be supplied to the plurality of area calculation units.

According to the present disclosure, a distance measuring system including: the light detecting device described above; and a light projection unit configured to project light to the object is provided.

### BRIEF DESCRIPTION OF DRAWINGS

FIG. 1 is a block diagram illustrating a schematic configuration example of a ToF sensor.

FIG. 2 is a diagram illustrating an optical system of a ToF sensor according to the present disclosure.

FIG. 3 is a block diagram illustrating a schematic configuration example of a light receiving unit according to the present disclosure.

FIG. 4 is a schematic view illustrating a schematic configuration example of an SPAD array according to the present disclosure.

FIG. 5 is a circuit diagram illustrating a schematic configuration example of an SPAD pixel according to the present disclosure.

FIG. 6 is a diagram illustrating an example of a depth image acquired by a ToF sensor.

FIG. 7 is a diagram illustrating an example of a histogram generated on the basis of a frame image acquired from an SPAD area responsible for a first area illustrated in FIG. 7.

FIG. 8 is a diagram illustrating an example of a histogram generated on the basis of a frame image acquired from an SPAD area responsible for a fourth area illustrated in FIG. 7.

FIG. 9 is a block diagram illustrating a schematic configuration example of a calculation unit according to a comparative example.

FIG. 10 is a block diagram illustrating a schematic configuration example of a calculation unit.

FIG. 11 is a diagram illustrating calculation coefficients.

FIG. 12 is a block diagram illustrating a schematic configuration example of a calculation unit.

FIG. 13 is a diagram illustrating a lamination structure example of a light receiving unit and a calculation unit of a ToF sensor.

FIG. 14 is a diagram illustrating an example of a planar layout of a light receiving face of a light receiving chip.

FIG. 15 is a diagram illustrating a planar layout example of a face of a circuit chip on a light receiving chip side.

FIG. 16 is a block diagram of a light detecting device according to a first embodiment.

FIG. 17 is a block diagram of a light detecting device according to a second embodiment.

FIG. 18 is a block diagram of a light detecting device according to a third embodiment.

FIG. 19 is a block diagram of a light detecting device according to a fourth embodiment.

FIG. 20 is a block diagram of a light detecting device according to a fifth embodiment.

FIG. 21 is a block diagram of a light detecting device according to a sixth embodiment.

FIG. 22 is a block diagram of a light detecting device according to a modified example of FIG. 21.

FIG. 23 is a block diagram of a light detecting device according to a seventh embodiment.

FIG. 24 is a block diagram of a light detecting device according to a modified example of FIG. 23.

FIG. 25A is a block diagram of a light detecting device according to an eighth embodiment.

FIG. 25B is a block diagram illustrating an internal configuration of a register block illustrated in FIG. 25A.

FIG. 26A is a block diagram of a light detecting device according to a ninth embodiment.

FIG. 26B is a block diagram illustrating an internal configuration of a register block disposed for each area calculation unit.

FIG. 27 is an operation timing diagram of a light detecting device according to a tenth embodiment.

FIG. 28 is an operation timing diagram of a light detecting device according to an 11th embodiment.

FIG. 29 is a block diagram of a light detecting device according to a 12th embodiment.

FIG. 30 is a block diagram of a light detecting device according to a 13th embodiment.

FIG. 31 is a block diagram illustrating an example of an overall configuration of a vehicle control system.

FIG. 32 is an explanatory diagram illustrating an example of positions at which a vehicle external information detecting unit and an imaging unit are installed.

### DESCRIPTION OF EMBODIMENTS

Hereinafter, embodiments of a light detecting device and a distance measuring system will be described with reference to the drawings. Hereinafter, although main components of the light detecting device and the distance measuring system will be mainly described, in the light detecting device and the distance measuring system, components or functions that are not illustrated or described may be present. The following description does not exclude components or functions that are not illustrated or described.

### (Distance Measuring System: ToF Sensor)

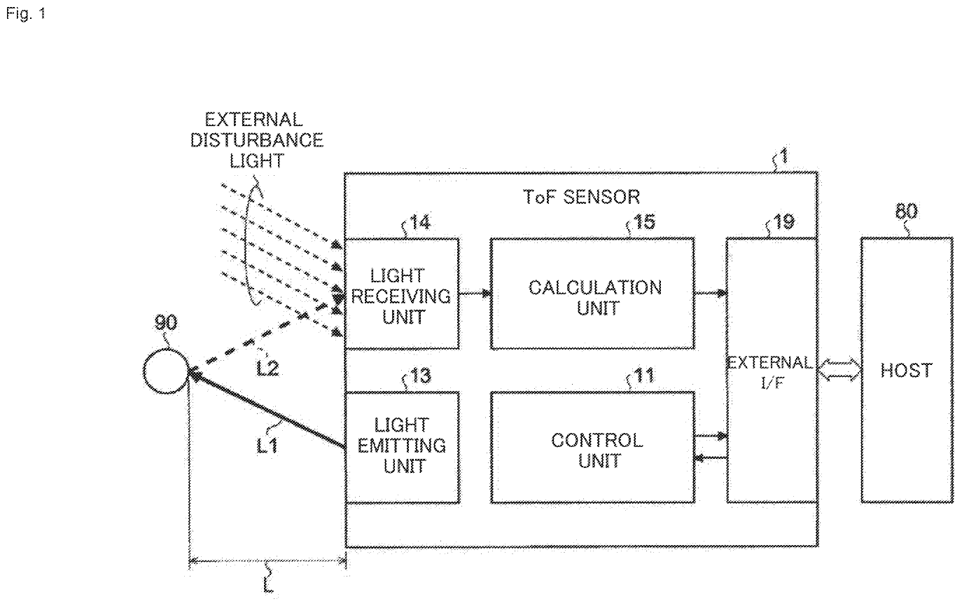

FIG. 1 is a block diagram illustrating a schematic configuration example of a ToF sensor as a distance measuring system including a light detecting device 10 according to the present disclosure. As illustrated in FIG. 1, the ToF sensor 1 includes a control unit 11, a light emitting unit 13, a light receiving unit 14, a calculation unit 15, and an external output interface (I/F) 19. The light receiving unit 14 and the calculation unit 15 configure a light detecting device 10.

The control unit 11 is configured as, for example, an information processing device such as a central processing unit (CPU) and controls each unit of the ToF sensor 1.

The external output I/F 19 may be, for example, a communication adapter for establishing communication with an external host 80 via a communication network in conformity with any standard such as not only a wireless local area network (LAN) or a wired LAN but also a controller area network (CAN), a local interconnect network (LIN), or FlexRay (registered trademark).

Here, for example, when the ToF sensor 1 is mounted in an automobile or the like, the host 80 may be an engine control unit (ECU) mounted in the automobile or the like. When the ToF sensor 1 is mounted in an autonomous moving robot such as a robot pet at home or an autonomous moving body such as robot cleaner, an unmanned aircraft, or follow-up conveyance robot, the host 80 may be a control device or the like that controls the autonomous moving body.

The light emitting unit 13, for example, includes one or a plurality of semiconductor laser diodes as light sources and emits laser light L1 having a pulse form of a predetermined time width with a predetermined period (also referred to as a light emission period). In addition, the light emitting unit 13, for example, emits laser light L1 having a time width of 1 nano seconds (ns) with a period of 1 megahertz (MHz). For example, in a case in which an object 90 is present within a distance measurement range, the laser light L1 emitted from the light emitting unit 13 is reflected by this object 90 and is incident in the light receiving unit 14 as reflective light L2.

Although details will be described below, the light receiving unit 14, for example, includes a plurality of single photon avalanche photodiode (SPAD) pixels arranged in a two-dimensional lattice pattern and outputs information relating to the number of SPAD pixels (hereinafter, referred to as a detection number) that have detected incidence of photons after light emission of the light emitting unit 13 (for example, corresponding to the number of detection signals to be described below). For example, the light receiving unit 14 detects the incidence of photons with a predetermined sampling period in response to one light emission of the light emitting unit 13 and outputs the number of detections.

The calculation unit 15 collects each detection number output from the light receiving unit 14 for a plurality of SPAD pixels (for example, corresponding to one or a plurality of macro pixels to be described below) and, on the basis of pixel values acquired by the collection thereof, generates a histogram having a horizontal axis as a flight time and a vertical axis as an accumulated pixel number. For example, by repeatedly performing acquisition of a pixel value by collecting detection numbers for light emission of one time from the light emitting unit 13 at a predetermined sampling frequency for light emission of a plurality of times from the light emitting unit 13, the calculation unit 15 generates a histogram having a horizontal axis (a bin of the histogram) as a sampling period corresponding to a flight time and a vertical axis as an accumulated pixel value acquired by accumulating pixel values acquired at each sampling period.

In addition, after performing a predetermined filter process on the generated histogram, the calculation unit 15 identifies a flight time at a time when the accumulated pixel value becomes a peak from the histogram after the filter process. Then, the calculation unit 15 calculates the distance from the ToF sensor 1 or a device on which the ToF sensor 1 is mounted to the object 90 present in the distance measurement range based on the identified flight time. The information of the distance calculated by the calculation unit 15, for example, may be output to the host 80 or the like via the external output I/F 19.

### (Optical System)

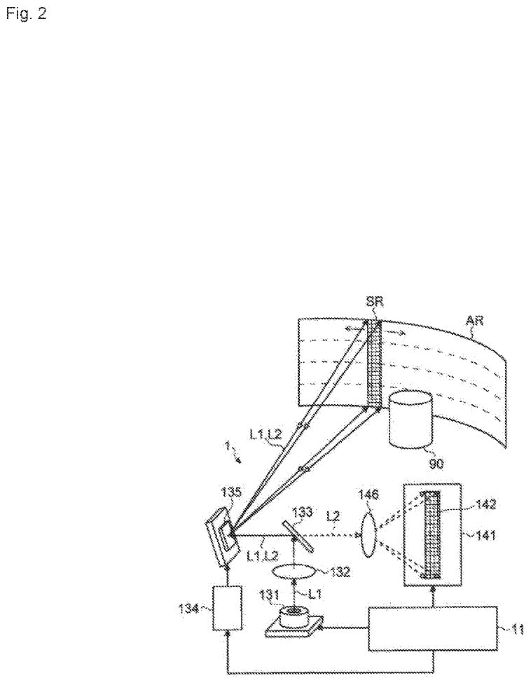

FIG. 2 is a diagram illustrating an optical system of a ToF sensor according to the present disclosure. FIG. 2 illustrates a so-called scanning-type optical system that scans the angle of view of the light receiving unit 14 in the horizontal direction. However, the optical system of the ToF sensor is not limited to this and may be, for example, that of a so-called flash-type ToF sensor in which the angle of view of the light receiving unit 14 is fixed.

As illustrated in FIG. 2, the ToF sensor 1 includes a light source 131, a collimator lens 132, a half mirror 133, a galvanometer mirror 135, a light receiving lens 146, and a SPAD array 141 as an optical system. The light source 131, the collimator lens 132, the half mirror 133, and the galvanometer mirror 135 are included, for example, in the light emitting unit 13 in FIG. 1. The light receiving lens 146 and the SPAD array 141 are included, for example, in the light receiving unit 14 in FIG. 1.

In the configuration illustrated in FIG. 2, laser light L1 emitted from the light source 131 is converted into parallel light of which an intensity spectrum of a cross-section has a rectangular shape that is long in the vertical direction by the collimator lens 132 and thereafter is incident in the half mirror 133. The half mirror 133 reflects a part of the incident laser light L1. The laser light L1 reflected by the half mirror 133 is incident in the galvanometer mirror 135. For example, the galvanometer mirror 135 is vibrated in a horizontal direction with a predetermined rotation axis set as its vibration center by a driving unit 134 operating on the basis of control from the control unit 11. In accordance with this, the laser light L1 is horizontally scanned such that the angle of view SR of the laser light L1 reflected by the galvanometer mirror 135 scans a distance measurement range AR in a horizontal direction in a reciprocating manner. In the driving unit 134, a Micro Electro Mechanical System (MEMS), a micromotor, or the like can be used.

The laser light L1 reflected by the galvanometer mirror 135 is reflected by the object 90 present in the distance measurement range AR and the reflective light L2 is incident on the galvanometer mirror 135. A part of the reflective light L2 that has been incident in the galvanometer mirror 135 is transmitted through the half mirror 133 and is incident in the light receiving lens 146, and, in accordance therewith, forms an image in a specific used SPAD array 142 in the SPAD array 141. In addition, the used SPAD array 142 may be the entire SPAD array 141 or may be a part thereof.

### (Light Receiving Unit)

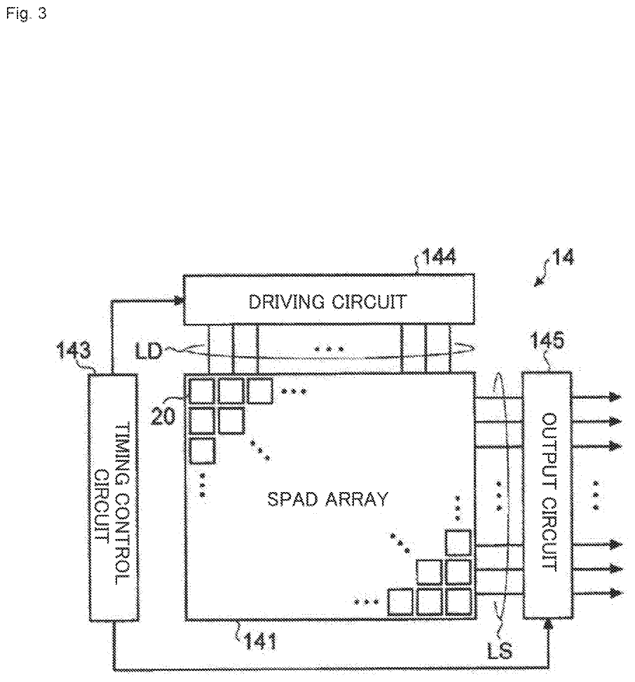

FIG. 3 is a block diagram illustrating a schematic configuration example of a light receiving unit according to the present disclosure. As illustrated in FIG. 3, the light receiving unit 14 includes a SPAD array 141, a timing control circuit 143, a driving circuit 144, and an output circuit 145.

The SPAD array 141 includes a plurality of SPAD pixels 20 arranged in a two-dimensional lattice pattern. A pixel driving line LD (a vertical direction in the drawing) is connected to the plurality of SPAD pixels 20 for each column, and an output signal line LS (a horizontal direction in the drawing) is connected thereto for each row. One ends of the pixel drive lines LD are connected to output ends of the driving circuit 144 corresponding to the columns and one ends of the output signal lines LS are connected to input ends of the output circuit 145 corresponding to the rows.

In FIG. 3, reflective light L2 is detected using the whole or a part of the SPAD array 141. In an area used in the SPAD array 141 (a used SPAD array 142), in a case in which the entire laser light L1 is reflected as reflective light L2, an image of the reflective light L2 formed in the SPAD array 141 as an image becomes a rectangular shape that is long in the vertical direction. However, the configuration is not limited thereto, and various modifications can be made such as a region larger or smaller than the image of the reflective light L2 formed on the SPAD array 141.

The driving circuit 144 includes a shift register, an address decoder, and the like and drives the SPAD pixels 20 of the SPAD array 141 all at the same time, column by column, or the like. Thus, the driving circuit 144 includes at least a circuit that applies a quench voltage V_QCH which will be described later to each SPAD pixel 20 in a selected column of the SPAD array 141 and a circuit that applies a selection control voltage V_SEL which will be described later to each SPAD pixel 20 in the selected column. Then, the driving circuit 144 selects SPAD pixels 20 used to detect the incidence of photons column by column by applying the selection control voltage V_SEL to a pixel drive line LD corresponding to a column to be read.

Signals (referred to as detection signals) V_OUT output from the SPAD pixels 20 in the column selected and scanned by the driving circuit 144 are input to the output circuit 145 through the output signal lines LS. The output circuit 145 inputs the detection signal V_OUT output from each SPAD pixel 20 to the calculation unit 15 to be described below.

The timing control circuit 143 includes a timing generator that generates various timing signals or the like and controls the driving circuit 144 and output circuit 145 based on the various timing signals generated by the timing generator.

### (SPAD Array)

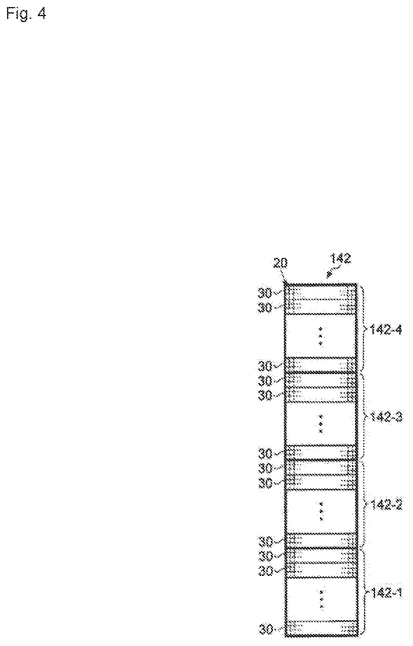

FIG. 4 is a schematic view illustrating a schematic configuration example of an SPAD array according to the present disclosure. As illustrated in FIG. 4, for example, a used SPAD array 142 has a configuration in which a plurality of SPAD pixels 20 are arranged in a two-dimensional lattice pattern. The plurality of SPAD pixels 20 are grouped into a plurality of macro pixels 30 each configured by a predetermined number of SPAD pixels 20 arranged in a row and/or column direction. A shape of an area acquired by joining outer edges of SPAD pixels 20 positioned on the outermost periphery of the macro pixels 30 forms a predetermined shape (for example, a rectangle).

For example, the used SPAD array 142 is configured by a plurality of macro pixels 30 arranged in a vertical direction (corresponding to a column direction). In the present disclosure, the used SPAD array 142, for example, is divided into a plurality of areas (hereinafter, referred to as SPAD areas) in the vertical direction. In the example illustrated in FIG. 4, the used SPAD array 142 is divided into four SPAD areas 142-1 to 142-4. The SPAD area 142-1 located at a lowermost position, for example, corresponds to a lowermost ¼ area in the angle of view SR of the used SPAD array 142, the SPAD area 142-2 positioned thereon, for example, corresponds to a second ¼ area from the bottom in the angle of view SR, the SPAD area 142-3 positioned thereon, for example, corresponds to a third ¼ area from the bottom in the angle of view SR, and the uppermost SPAD area 142-4, for example, corresponds to an uppermost ¼ area in the angle of view SR.

### (SPAD PIXEL)

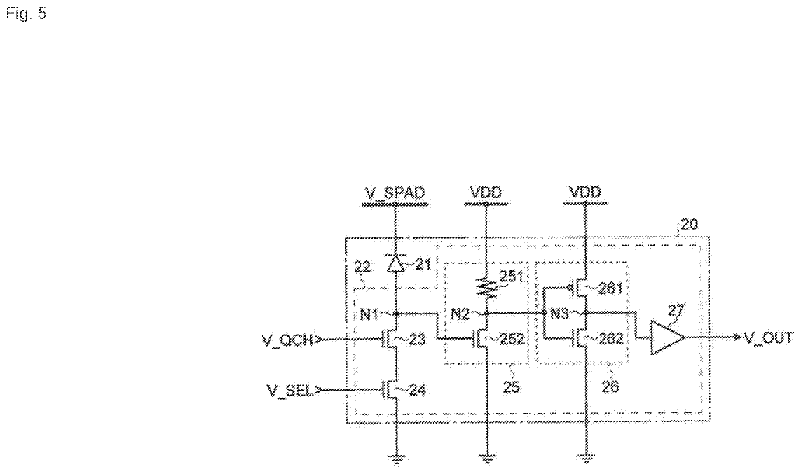

FIG. 5 is a circuit diagram illustrating a schematic configuration example of an SPAD pixel 20 according to the present disclosure. As illustrated in FIG. 5, the SPAD pixel 20 includes a photodiode 21 as a light receiving element and a reading circuit 22 that detects incidence of photons in the photodiode 21. In a state in which a reverse bias voltage V_SPAD equal to or higher than a breakdown voltage or more is applied between an anode and a cathode of the photodiode 21, when photons are incident, the photodiode 21 generates an avalanche current.

The reading circuit 22 includes a quench resistor 23, a digital converter 25, an inverter 26, a buffer 27, and a selection transistor 24. The quench resistor 23, for example, is configured using an N-type Metal Oxide Semiconductor Field Effect Transistor (MOSFET; hereinafter, referred to as an NMOS transistor), a drain thereof is connected to the anode of the photodiode 21, and a source thereof is grounded through the selection transistor 24. Further, a preset quench voltage V_QCH for allowing the NMOS transistor to act as a quench resistor is applied to a gate of the NMOS transistor constituting the quench resistor 23 from the driving circuit 144 via a pixel drive line LD.

The photodiode 21 illustrated in FIG. 5 is a SPAD. The SPAD is an avalanche photodiode that operates in a Geiger mode when a reverse bias voltage equal to or higher than the breakdown voltage is applied between an anode and a cathode thereof and can detect the incidence of a photon.

The digital converter 25 includes a resistor 251 and an NMOS transistor 252. A drain of the NMOS transistor 252 is connected to a power supply voltage VDD via the resistor 251 and a source thereof is grounded. In addition, a voltage at a connection node N1 between the anode of the photodiode 21 and the quench resistor 23 is applied to a gate of the NMOS transistor 252.

The inverter 26 includes a P-type MOSFET (hereinafter referred to as a PMOS transistor) 261 and an NMOS transistor 262. A drain of the PMOS transistor 261 is connected to the power supply voltage VDD and a source thereof is connected to a drain of the NMOS transistor 262. The drain of the NMOS transistor 262 is connected to the source of the PMOS transistor 261 and a source thereof is grounded. A voltage at a connection node N2 between the resistor 251 and the drain of the NMOS transistor 252 is applied to a gate of the PMOS transistor 261 and the gate of the NMOS transistor 262. An output of the inverter 26 is input to the buffer 27.

The buffer 27 is a circuit for impedance conversion. When an output signal is input to the buffer 27 from the inverter 26, the buffer 27 impedance-converts the input output signal and outputs the converted signal as a detection signal V_OUT.

The selection transistor 24 is, for example, an NMOS transistor, a drain thereof is connected to the source of the NMOS transistor constituting the quench resistor 23, and a source thereof is grounded. The selection transistor 24 is connected to the driving circuit 144. The selection transistor 24 changes from off to on when the selection control voltage V_SEL from the driving circuit 144 has been applied to a gate of the selection transistor 24 via the pixel drive line LD.

### (Schematic Operation Example of SPAD Pixel)

The reading circuit 22 illustrated in FIG. 5, for example, operates as below. In other words, first, in a period in which a selection control voltage V_SEL is applied from the driving circuit 144 to the selection transistor 24, and the selection transistor 24 is in an on-state, a reverse vias voltage V_SPAD equal to or higher than a breakdown voltage is applied to the photodiode 21. In accordance with this, the operation of the photodiode 21 is allowed.

On the other hand, in a period in which the selection control voltage V_SEL is not applied from the driving circuit 144 to the selection transistor 24, and the selection transistor 24 is in an off-state, the reverse bias voltage V_SPAD is not applied to the photodiode 21, and thus the operation of the photodiode 21 is prohibited.

In a case in which a photon is incident in the photodiode 21 when the selection transistor 24 is in the on-state, an avalanche current is generated in the photodiode 21. In accordance therewith, the avalanche current flows through the quench resistor 23, and the voltage of the connection node N1 rises. When the voltage of the connection node N1 becomes higher than the on-voltage of the NMOS transistor 252, the NMOS transistor 252 comes into the on-state, and the voltage of the connection node N2 changes from the power supply voltage VDD to 0 V. Then, when the voltage of the connection node N2 changes from the power supply voltage VDD to 0 V, the PMOS transistor 261 changes from the off state to the on state, the NMOS transistor 262 changes from the on state to the off state, and the voltage of the connection node N3 changes from 0 V to the power supply voltage VDD.

As a result, a high-level detection signal V_OUT is output from the buffer 27.

Thereafter, when the voltage of the connection node N1 continues to rise, the voltage applied between the anode and the cathode of the photodiode 21 becomes lower than the breakdown voltage, and, in accordance therewith, the avalanche current stops, and the voltage of the connection node N1 falls. Then, when the voltage of the connection node N1 becomes lower than the on voltage of the NMOS transistor 252, the NMOS transistor 252 comes into the off state, and the output of the detection signal V_OUT from the buffer 27 stops (low level).

In this way, in a period from a timing at which a photon is incident in the photodiode 21 to generate an avalanche current, and in accordance with this, the NMOS transistor 252 comes into the on state to a timing at which the avalanche current stops, and the NMOS transistor 252 comes into the off state, the reading circuit 22 outputs a detection signal V_OUT of the high level. The output detection signal V_OUT is input to the calculation unit 15 through the output circuit 145.

### (Depth Image)

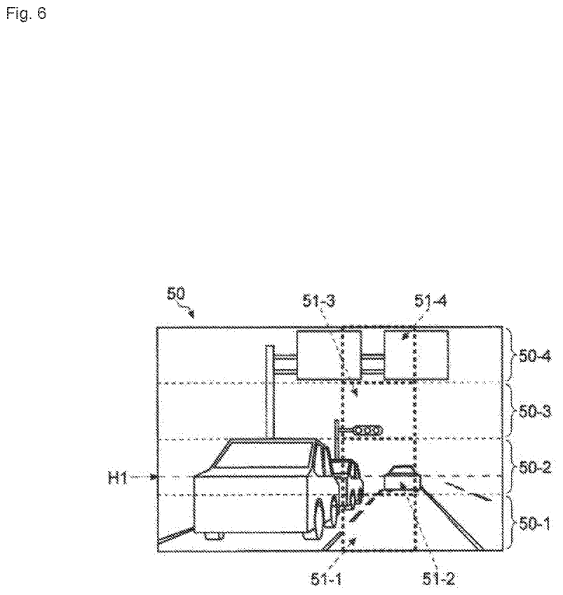

FIG. 6 is a diagram illustrating an example of a depth image acquired by a ToF sensor according to the present disclosure and is a diagram illustrating an example of a depth image acquired by the ToF sensor 1 installed in a state in which it faces the front side of a vehicle. As illustrated in FIG. 6, in the present disclosure, when laser light L1 is scanned once in a horizontal direction, a depth image 50 corresponding to a distance measurement range AR is acquired as depth information of a depth to an object present within the distance measurement range AR. Thus, as illustrated in FIG. 4, in a case in which the vertically-long used SPAD array 142 is vertically divided into four parts, the depth image 50 can be divided into four areas 50-1 to 50-4 that are vertically aligned. Here, the first area 50-1 is a depth image acquired in the SPAD area 142-1, the second area 50-2 is a depth image acquired in the SPAD area 142-2, the third area 50-3 is a depth image acquired in the SPAD area 142-3, and the fourth area 50-4 is a depth image acquired in the SPAD area 142-4.

The first area 50-1 positioned on the lowermost side, for example, is a depth image near the bottom of a vehicle in which the ToF sensor 1 is mounted. Thus, in the first area 50-1, for example, there is a high possibility of an object present at a short distance from a vehicle such as a road face, a white line, a curbstone, or the like being included.

The fourth area 50-4 positioned on the uppermost side, for example, is a depth image near an upper side of the vehicle. Thus, in the fourth area 50-4, for example, there is a high possibility of an object present at a long distance from the vehicle such as a sign, a signboard, or the like being included.

The second area 50-2, for example, is a depth image of a front lower side of the vehicle. Thus, in the second area 50-2, for example, there is a high possibility of an object at an intermediate distance between the short distance and the long distance such as a preceding vehicle having a short inter-vehicle distance, a road face, or the like being included.

The third area 50-3, for example, is a depth image of a front upper side of the vehicle. Thus, in the third area 50-3, for example, there is a high possibility of an object present at a distance that is an intermediate distance between the short distance and the long distance and is present at a distance longer than that of an object having a high possibility of being included in the second area 50-2 such as a preceding vehicle having a long inter-vehicle distance, an on-road workpiece such as a traffic light or the like being included.

In addition, the horizontal line H1 may be included in the second area 50-2 or may be included in the third area 50-3. Furthermore, the configuration is not limited to these, and the horizontal line may be included in the first or fourth area 50-1 or 50-4 or may not be included in any of the areas 50-1 to 50-4.

In addition, for emission of the laser light L1 for acquisition of a depth image of a certain area (a certain angle of view) performed once or more, a frame image of an area corresponding to the angle of view of the used SPAD array 142 denoted by a dotted line in FIG. 6 is acquired. Thus, in a case in which the used SPAD array 142 is vertically divided into four parts, for emission of laser light L1 for acquisition of a depth image of a certain area (a certain angle of view) performed once or a plurality of number of times, a frame image 51-1 corresponding to the angle of view of the SPAD area 142-1, a frame image 51-2 corresponding to the angle of view of the SPAD area 142-2, a frame image 51-3 corresponding to the angle of view of the SPAD area 142-3, and a frame image 51-4 corresponding to the angle of view of the SPAD area 142-4 are acquired. In addition, the frame images 51-1 to 51-4 are sled in a horizontal direction in addition to scanning of laser light L1 in the horizontal direction.

### (Histogram)

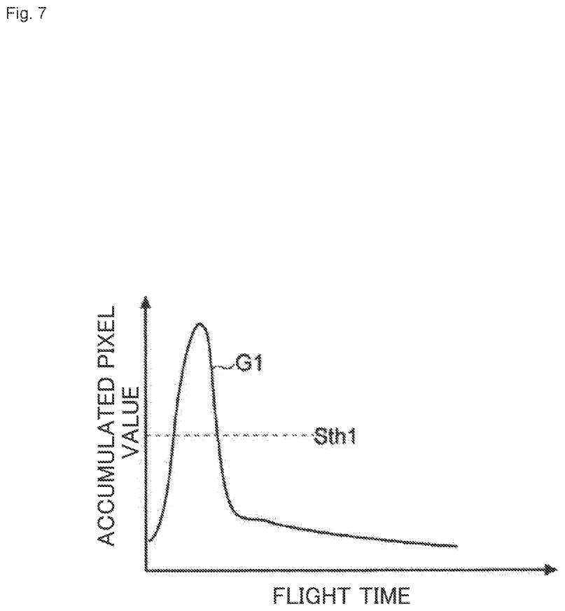

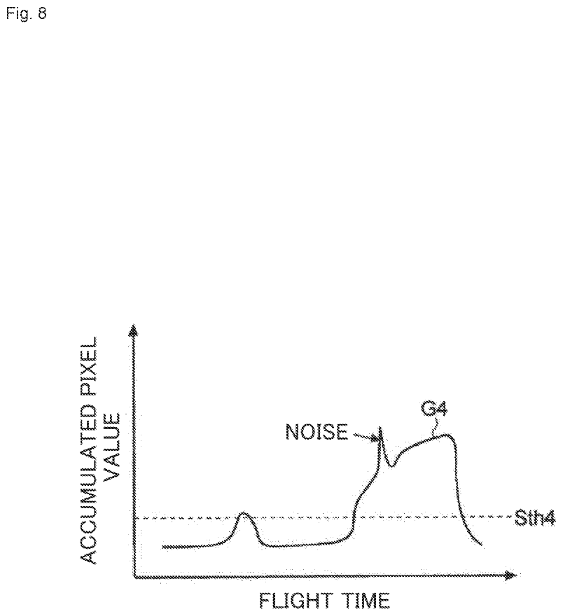

Here, when the first area 50-1 positioned on the lowermost side and the fourth area 50-4 positioned on the uppermost side are focused, generally, an object present near the bottom of a device corresponding to the first area 50-1 is positioned near the device, and an object present near the upper side of a device corresponding to the fourth area 50-4 is positioned far from the device. Thus, as illustrated in FIG. 7, in a histogram G1 generated on the basis of the frame image 51-1 acquired from the SPAD area 142-1 responsible for the first area 50-1, an accumulated pixel value becomes a peak in a short flight time, and, as illustrated in FIG. 8, in a histogram G4 generated on the basis of the frame image 51-4 acquired from the SPAD area 142-4 responsible for the fourth area 50-4, an accumulated pixel value becomes a peak in a long flight time.

(Problem of Case in which Calculation Coefficient is Configured to be Common)

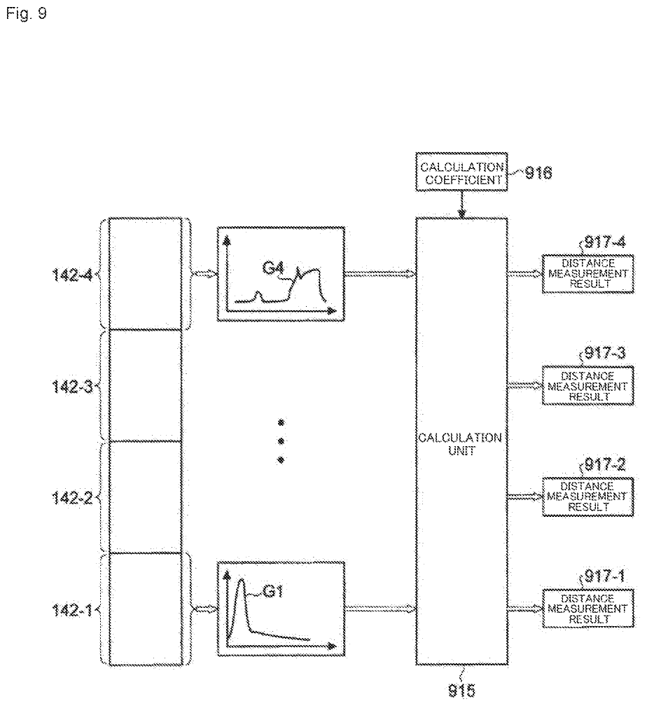

For this reason, as illustrated in FIG. 9, in a case in which, for the frame images 51-1 to 51-4 respectively acquired from the SPAD areas 142-1 to 142-4, calculation processes for calculating distances to objects are performed using a common calculation unit 915 and a common calculation coefficient 916, it cannot be determined that distance measurement results 917-1 to 917-4 thereof are calculated using optimal calculation coefficients, and in accordance therewith, there is a possibility of the distance measurement accuracy being degraded.

### (Calculation Process According to Present Disclosure)

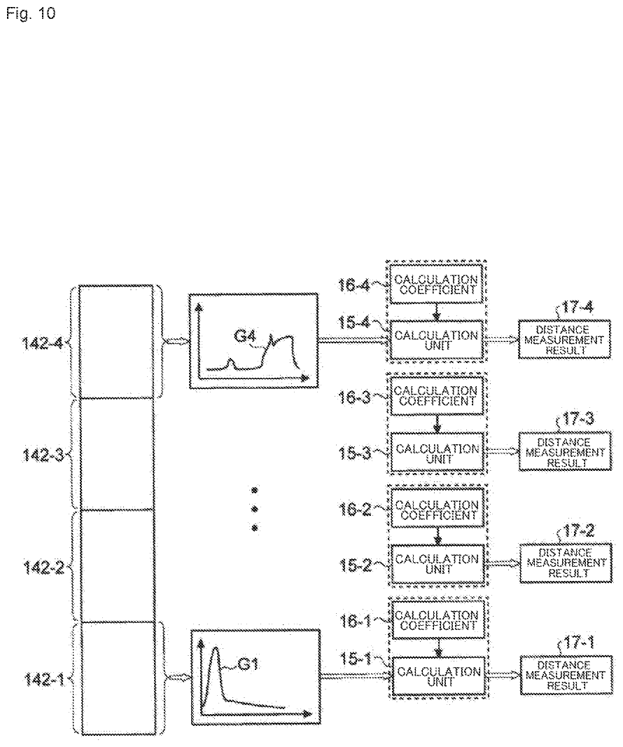

Thus, in the present disclosure, as illustrated in FIG. 10, the calculation unit 15 is divided into four area calculation units 15-1 to 15-4 so as to respectively form one pair with the four SPAD areas 142-1 to 142-4, and individual calculation coefficients 16-1 to 16-4 are set to the area calculation units 15-1 to 15-4.

By configuring as such, individual calculation coefficients 16-1 to 16-4 according to predicted distances to objects can be respectively set to the area calculation units 15-1 to 15-4, and thus respective distance measurement results 17-1 to 17-4 can be calculated using optimal calculation coefficients. In accordance therewith, even in a case in which an object at a short distance and an object at a long distance are present within the distance measurement range AR, degradation of the distance measurement accuracy can be inhibited.

For example, for the area calculation unit 15-1 corresponding to the SPAD area 142-1 in which an object may be easily present at a short distance, a high threshold Sth1 (see FIG. 7) can be set as a threshold for extracting a component of reflective light L2 from detected light as the calculation coefficient 16-1, and a filter coefficient for eliminating a noise component of a low frequency can be set, and, for the area calculation unit 15-4 corresponding to the SPAD area 142-4 in which an object may be easily present at a long distance, a low threshold Sth4 (see FIG. 8) can be set as a threshold as the calculation coefficient 16-4, and a filter coefficient for eliminating a noise component of a high frequency can be set.

In addition, similarly, also for the area calculation units 15-2 and 15-3, optimal calculation coefficients 16-2 and 16-3 can be set in accordance with distances to objects that are predicted in the second area 50-2 and the third area 50-3.

### (Example of Calculation Coefficient)

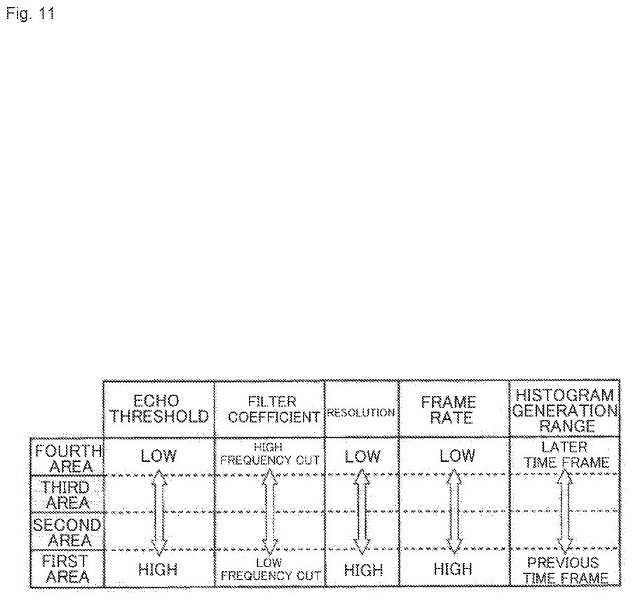

As examples of the calculation coefficients 16-1 to 16-4 respectively set by the area calculation units 15-1 to 15-4 according to the present disclosure, for example, as illustrated in FIG. 11, there are a threshold for extracting a component of reflective light L2 from detected light (hereinafter, referred to as an echo threshold) and a filter coefficient for eliminating a noise component (hereinafter, referred to as an filter coefficient) described above, a resolution of a depth image to be acquired (hereinafter, simply referred to as a resolution), a frame rate with which a depth image is read from the used SPAD array 142 (hereinafter, simply referred to as a frame rate), an output range (time frame) of a histogram (hereinafter, referred to as a histogram output range), and the like.

The echo threshold, as described above, is a threshold used for extracting a component of reflective light L2 from light detected by the SPAD pixel 20 and, as illustrated in FIG. 11, for example, may be set such that it becomes higher toward the first area 50-1 in which there is a high possibility of presence of an object at a short distance, and it becomes lower toward the fourth area 50-4 in which there is a high possibility of presence of an object at a long distance.

As described above, the filter coefficient is a filter coefficient used for eliminating a noise component from a generated histogram and, as illustrated in FIG. 11, for example, a filter coefficient for cutting a low frequency component may be set toward the first area 50-1, and a filter coefficient for cutting a high frequency component may be set toward the fourth area 50-4.

As described above, the resolution, for example, can be changed by changing the number of macro pixels 30 configuring one pixel. As illustrated in FIG. 11, this resolution, for example, may be set such that it becomes higher toward the first area 50-1 and it is set to a lower value toward the fourth area 50-4. By lowering the resolution, the dynamic range of one pixel can be widened, and thus weak reflective light L2 reflected by an object located at a long distance can be detected. On the other hand, by raising the resolution, a finer depth image can be acquired, and thus the distance measurement accuracy can be raised.

For example, by changing a bin number of a histogram generated by a histogram circuit 152 to be described below and the emission period of the light emitting unit 13, the frame rate can be changed. For example, by configuring the bin number of the histogram to be in half and doubling the emission period of the light emitting unit 13, the frame rate can be doubled. As illustrated in FIG. 11, this frame rate, for example, may be set such that it becomes higher toward the first area 50-1, and it becomes lower toward the fourth area 50-4. By raising the frame rate, a distance to an object can be measured at a higher cycle, and thus a response to the object can be quickly started. On the other hand, by lowering the frame rate, the data processing amount can be reduced, and thus shortening of a processing time and reduction of power consumption can be achieved.

For example, the histogram output range can be changed by changing a range (a time frame) of the generated histogram to be output. For example, in a case in which a distance to an object positioned at a short distance is calculated, by outputting a previous time frame of the histogram, an output band can be reduced. On the other hand, in a case in which a distance to an object positioned at a long distance is calculated, by outputting a subsequent time frame of the histogram, similarly, the output band can be reduced. As illustrated in FIG. 11, the output range of this histogram, for example, may be set to a further previous time frame of the histogram toward the first area 50-1 and may be set to a further subsequent time frame of the histogram toward the fourth area 50-4. By narrowing down the output range of the histogram, the data processing amount can be reduced, and thus shortening of the processing time and reduction of the power consumption can be achieved.

Here, the calculation coefficients described above are merely simple examples, and various additions and changes can be made. For example, a value at the time of subtracting noise according to external disturbance light from the histogram, a sampling frequency, and the like may be included in the calculation coefficients.

### (Schematic Configuration Example of Calculation Unit)

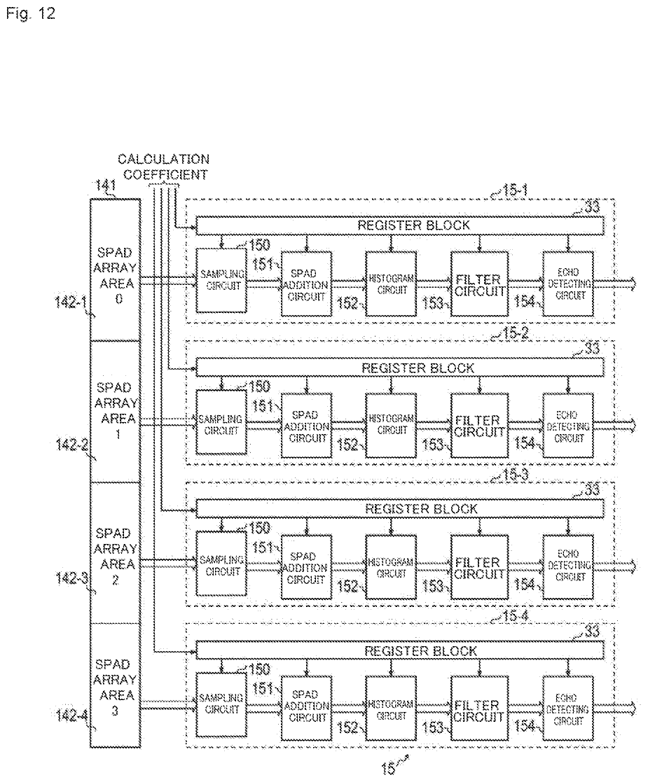

FIG. 12 is a block diagram illustrating a schematic configuration example of the calculation unit according to the present disclosure. As illustrated in FIG. 12, each of the area calculation units 15-1 to 15-4 includes a sampling circuit 150, a SPAD addition circuit 151, a histogram circuit 152, a filter circuit 153, an echo detecting circuit 154, and a register block 155.

The register block 155, for example, is a memory area configured using a static random access memory (SRAM) or the like and stores individual calculation coefficients used in a calculation process performed by each of the sampling circuit 150, the SPAD addition circuit 151, the histogram circuit 152, the filter circuit 153, and the echo detecting circuit 154 belonging to a corresponding area calculation unit.

For example, the sampling circuit 150 converts a pulse waveform of a signal V_OUT output from the SPAD array 141 through the output circuit 145 into a detection signal of a pulse waveform of a time width according to an operation clock of the SPAD addition circuit 151 in accordance with a resolution among calculation coefficients stored in the register block 155 of a corresponding area calculation unit and outputs the detection signal.

By counting detection signals V_OUT input from the corresponding macro pixel 30 for each sampling period, the SPAD addition circuit 151 counts the number of SPAD pixels 20 in which incidence of a photon has been detected (a detection number) for each sampling period and outputs this counted value as a pixel value of the macro pixel 30.

Here, the sampling period is the interval at which the time from the emission of the laser light L1 by the light emitting unit 13 to the detection of the incidence of a photon by the light receiving unit 14 (flight time) is measured. A period shorter than the light emission period of the light emitting unit 13 is set for this sampling period. For example, shortening the sampling period enables calculation of the flight time of a photon emitted from the light emitting unit 13 and reflected by the object 90 with a higher time resolution. This means that increasing the sampling frequency enables calculation of the distance to the object 90 with a higher distance measuring resolution.

For example, in a case in which a flight time until reflective light L2 is incident in the light receiving unit 14 after the light emitting unit 13 emits laser light L1, and this laser light L1 is reflected by an object 90 is denoted by t, the speed of light C is constant (C≈300,000,000 m (meters)/s (second), and thus a distance L to the object 90 can be calculated as in the following Equation (1).

$$L = C \times t / 2 \qquad ( 1 )$$

Thus, when the sampling frequency is 1 GHz, a sampling period is 1 ns (nano seconds). In that case, one sampling period corresponds to 15 cm (centimeters). This indicates that a distance measurement resolution is 15 cm in a case in which the sampling frequency is 1 GHz. In addition, when the sampling frequency is doubled to be 2 HGz, the sampling period becomes 0.5 ns (nano seconds), and thus one sampling period corresponds to 7.5 cm (centimeters). This indicates that the distance measuring resolution can be halved when the sampling frequency is doubled. Thus, increasing the sampling frequency and shortening the sampling period enables calculation of the distance to the object 90 with higher accuracy.

The histogram circuit 152, for example, adds a pixel value of each pixel synchronously calculated by the sampling circuit 150 to a value of a bin corresponding to a sampling period in the histogram of the pixel, that is, a bin corresponding to a flight time in accordance with a frame rate among calculation coefficients stored in the register block 155 of a corresponding area calculation unit and/or a generation range of the histogram, thereby generating a histogram of each pixel (for example, see FIG. 7 or 8).

The filter circuit 153, for example, performs a filter process on the histogram generated by the histogram circuit 152 in accordance with a filter coefficient of noise cut among calculation coefficients stored in the register block 155 of a corresponding area calculation unit, thereby eliminating noise of a frequency band according to the filter coefficient.

For example, in accordance with an echo threshold among calculation coefficients stored in the register block 155 of a corresponding area calculation unit, the echo detecting circuit 154 extracts a component of reflective light L2 from the histogram after noise elimination and calculates a distance to an object drawn in each pixel from a bin number (a flight time) in which an accumulated pixel value becomes a peak in the extracted component of the reflective light L2.

The frame images 51-1 to 51-4 configured using the distances to objects calculated as described above, for example, may be input to the host 80 through the control unit 11 or the external output I/F 19.

### (Chip Configuration Example of Light Receiving Unit and Calculation Unit)

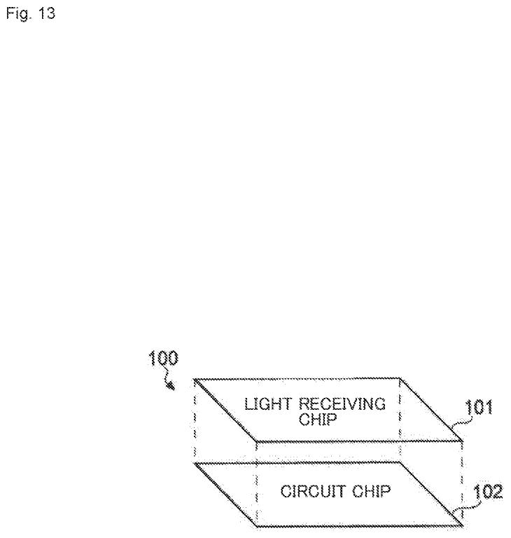

FIG. 13 is a diagram illustrating a lamination structure example of a light receiving unit and a calculation unit of a ToF sensor according to the present disclosure. As illustrated in FIG. 13, the light receiving unit 14 and the calculation unit 15 have a structure of a lamination chip 100 in which the light receiving chip 101 and the circuit chip 102 are vertically bonded. The light receiving chip 101, for example, is a semiconductor chip including an SPAD array 141 in which photodiodes 21 of the SPAD pixels 20 of the light receiving unit 14 are arranged, and the circuit chip 102, for example, is a semiconductor chip in which components other than the photodiode 21 of the SPAD pixel 20 of the light receiving unit 14 and the calculation unit 15 illustrated in FIG. 1 are arranged.

In bonding between the light receiving chip 101 and the circuit chip 102, for example, so-called direct bonding in which bonding faces thereof are planarized, and both chips are bonded using an inter-electron force can be used. However, the configuration is not limited thereto, and, for example, so-called CU-CU bonding in which electrode pads made of copper (Cu) formed on bonding faces thereof are bonded or any other bonding such as bump bonding can be used.

In addition, the light receiving chip 101 and the circuit chip 102 are electrically connected to each other through a connection portion such as a through-silicon via (TSV) penetrating a semiconductor substrate. In connection using a TSV, for example, a so-called twin TSV method for connecting two TSVs, that is, a TSV provided in the light receiving chip 101 and a TSV provided from the light receiving chip 101 to the circuit chip 102 on the outer surfaces of the chips, a so-called shared TSV method for connecting the light receiving chip 101 and the circuit chip 102 through a TSV penetrating both of the chips, or the like can be adopted.

However, in a case where a Cu-Cu junction or bump junction is used to join the light receiving chip 101 and the circuit chip 102 together, both the light receiving chip 3121 and the circuit chip 3122 are electrically connected to each other through a Cu-Cu joining portion or a bump joining portion.

In addition, in the lamination chip 100 illustrated in FIG. 13, components are not limited to the light receiving unit 14 and the calculation unit 15, and the light emitting unit 13, the control unit 11, and other components may be included therein.

### (Planar Layout Example of Each Chip)

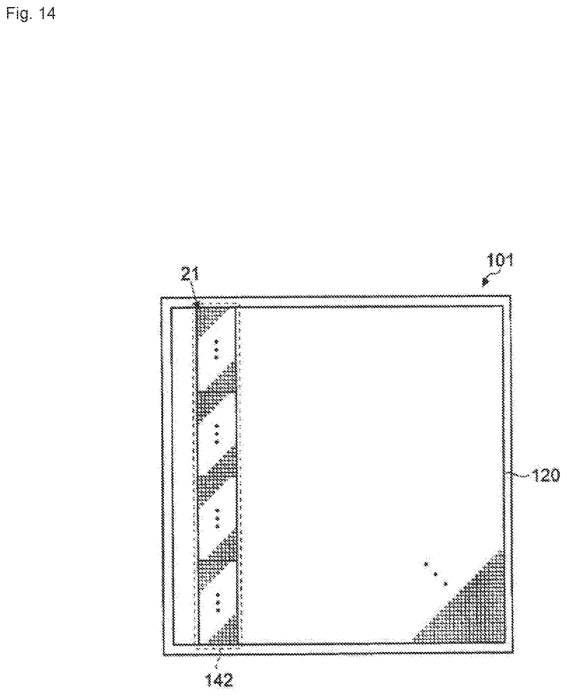

FIG. 14 is a diagram illustrating an example of the planar layout of the light receiving face of the light receiving chip 101. As illustrated in FIG. 14, an effective pixel area 120 of the light receiving face of the light receiving chip 101 has a configuration in which a plurality of photodiodes 21 are arranged in a two-dimensional lattice pattern. The photodiodes 21 of the SPAD pixels 20 belonging to the used SPAD array 142 may be some of photodiodes 21 of the effective pixel area 120 or may be all the photodiodes 21.

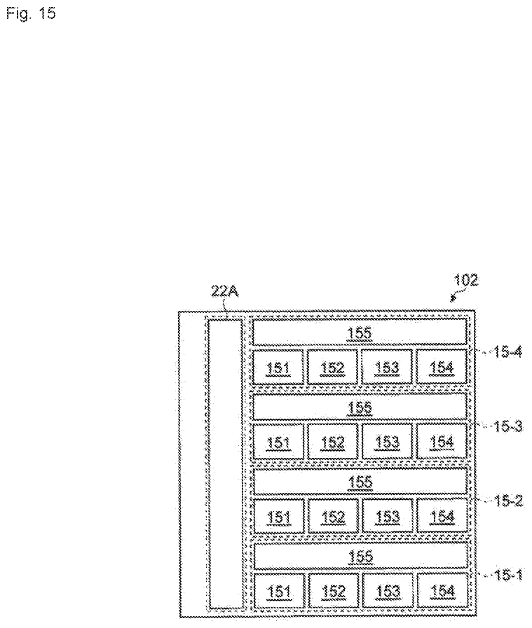

FIG. 15 is a diagram illustrating a planar layout example of a face of a circuit chip 102 on a light receiving chip 101 side. As illustrated in FIG. 15, in an area of the circuit chip 102 corresponding to the area of the used SPAD array 142, a reading circuit area 22A in which reading circuits 22 of the SPAD pixels 20 are arranged in a two-dimensional lattice pattern is disposed. In addition, in an area adjacent to the reading circuit area 22A, four area calculation units 15-1 to 15-4 are disposed in parallel with each other.

In each of the area calculation units 15-1 to 15-4, in order from an area closest to the reading circuit area 22A, a sampling circuit 150, a histogram circuit 152, a filter circuit 153, and an echo detecting circuit 154 are disposed. In this way, by disposing the components in order of performing the process for a detection signal output from the reading circuit 22, a wiring length from reading to output can be shortened, and thus a signal delay and the like can be decreased.

In addition, the register block 155 is disposed in parallel with the sampling circuit 150, the histogram circuit 152, the filter circuit 153, and the echo detecting circuit 154. In this way, by disposing the register block 155 to be adjacent to the sampling circuit 150, the histogram circuit 152, the filter circuit 153, and the echo detecting circuit 154, drawing out of signal lines from the register block 155 to circuits can be simplified.

In addition, as described above, by dividing the calculation unit 15 into four area calculation units 15-1 to 15-4, circuit design of individual area calculation units can be easily performed, a circuit pattern of one area calculation unit can be used in the other three area calculation units, and thus there is an advantage in that efforts and a time required for the circuit design can be significantly shortened can be acquired.

In the light detecting device 10 and the distance measuring system illustrated in FIGS. 1 to 15, the angle of view of the used SPAD array 142 is divided into a plurality of areas (corresponding to the frame images 51-1 to 51-4), independent calculation coefficients can be set for each area, and thus optimal calculation coefficients for each area can be set in accordance with a distance to an object having a high possibility of being present in each area. In accordance therewith, a distance to an object can be calculated using optimal calculation coefficients for each area, and thus, for example, even in a case in which an object at a short distance and an object at a long distance are present within the distance measurement range AR, degradation of distance measurement accuracy can be inhibited.

In addition, since the area calculation units 15-1 to 15-4 for each area can be configured to have the same circuit pattern, efforts and a time required for circuit design can be significantly shortened.

Furthermore, for example, in a case in which a distance measuring process is not performed for a part of the areas, power supply to a corresponding calculation unit (any one of the area calculation units 15-1 to 15-4) can be stopped, and thus there is also an advantage in that power consumption can be reduced in accordance with a situation.

In addition, in the light detecting device 10 and the distance measuring system 1 illustrated in FIGS. 1 to 15, although a case in which the angle of view SR of the used SPAD array 142 is scanned in the horizontal direction in a reciprocating manner has been illustrated, the configuration is not limited thereto, and, the angle of view SR of the used SPAD array 142 may be configured to be scanned in a vertical direction in a reciprocating manner with the longitudinal direction of the used SPAD array 142 set as a horizontal direction.

As illustrated in FIG. 12, the light detecting device 10 and the distance measuring system 1 illustrated in FIGS. 1 to 15 include a plurality of the area calculation units 15-1 to 15-4, each of the area calculation units 15-1 to 15-4 includes the sampling circuit 150, the histogram circuit 152, the filter circuit 153, and the echo detecting circuit 154, and thus, although the internal configuration is complicated, a malfunction diagnosis function is not included. For this reason, also when a part of circuits of the inside of the distance measuring system 1 has a malfunction, the malfunction cannot be quickly detected, and thus the light detecting device 10 and the distance measuring system 1 are not sufficient from the point of view of functional safety.

Thus, a light detecting device 10 and a distance measuring system 1 described below have a feature of having a malfunction diagnosis function. More specifically, the light detecting device 10 according to the present disclosure includes a malfunction detecting unit 4 in addition to a SPAD array (an array unit) 141 and a calculation unit 15. The SPAD array is similar to the SPAD array illustrated in FIG. 1, has a plurality of light reception areas, and a plurality of light receiving elements (photodiodes 21) are disposed inside each light reception area. The calculation unit 15 generates a histogram relating to the number of times of reception of light in the light receiving element 21 inside a pixel and a light reception timing for each pixel including one or more light receiving elements 21 included in each of the plurality of light reception areas. The malfunction detecting unit 4 detects a malfunction inside the calculation unit 15. A plurality of candidates may be considered for a specific configuration of the malfunction detecting unit 4, and thus they will be sequentially described.

### First Embodiment

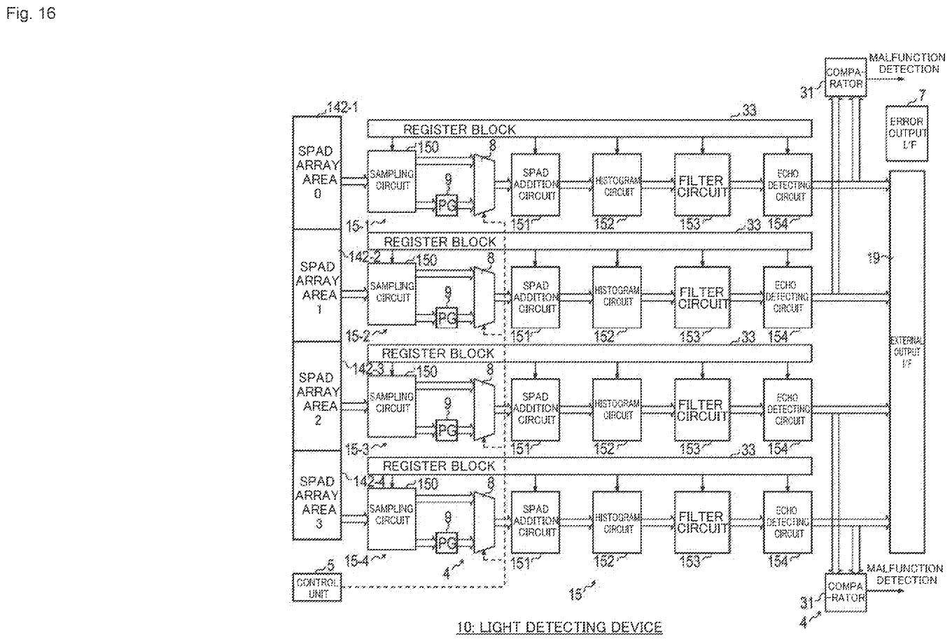

FIG. 16 is a block diagram of a light detecting device 10 according to a first embodiment. Similar to FIG. 12, the light detecting device 10 illustrated in FIG. 16 includes a SPAD array 141 divided into four areas 142-1 to 142-4, a calculation unit 15, a malfunction detecting unit 4, a control unit 5, an external output interface unit (hereinafter, referred to as an external output I/F) 19, and an error output I/F 7. Hereinafter, four divisional areas inside the SPAD array 141 will be referred to as SPAD array areas 0 to 3 (142-1 to 142-4).

The calculation unit 15 has four area calculation units 15-1 to 15-4 corresponding to the SPAD array areas 0 to 3 (142-1 to 142-4). Each of the four area calculation units 15-1 to 15-4 includes at least some circuits of a sampling circuit 150, a SPAD addition circuit 151, a histogram circuit 152, a filter circuit 153, an echo detecting circuit 154, and a register block 33. Each circuit inside the area calculation units 15-1 to 15-4 performs an operation similar to that illustrated in FIG. 12. Output signals of the area calculation units 15-1 to 15-4 are output to the outside through the external output I/F 19. The register block 33 stores calculation coefficients that are optimal for each processing circuit inside a corresponding one of the area calculation units 15-1 to 15-4 to perform a calculation process.

The sampling circuit 150 samples output signals of a plurality of light receiving elements 21 included in each of a plurality of light reception areas with a predetermined sampling period and outputs a detection signal indicating that the plurality of light receiving elements 21 have received light for each pixel. The SPAD addition circuit 151 generates a pixel value acquired by adding the number of detection signals for each pixel (macro pixel 30). The histogram circuit 152 generates a histogram of each pixel in each of a plurality of light reception areas on the basis of the pixel value generated by the SPAD addition circuit 151. The filter circuit 153 eliminates a noise component included in the histogram generated by the histogram circuit 152. The echo detecting circuit 154 detects a time difference until light is reflected by an object and is received by the array unit after the light is projected on the basis of the histogram after a noise component is eliminated by the filter circuit 153, thereby measuring a distance to the object.

The malfunction detecting unit 4 inputs the same test pattern to two area calculation units among four area calculation units 15-1 to 15-4 and determines that one of the two area calculation units has a malfunction when output signals of the two area calculation units are not the same.

The malfunction detecting unit 4 includes four selectors 8 and four pattern generators (PG) 9 corresponding to four area calculation units 15-1 to 15-4 and two comparators 31.

Each of the pattern generators 9 generates a test pattern signal at the time of performing a malfunction diagnosis. Four pattern generators 9 inside the malfunction detecting unit 4 respectively generate test pattern signals. The generated test pattern signals are respectively input to the corresponding selectors 8. Each pattern generator 9 changes a test pattern signal in accordance with the time. For example, each pattern generator 9 generates a test pattern signal of which a pattern is randomly changed in accordance with the time. Each pattern generator 9 may generate a test pattern signal using a pseudo random number. Two pattern generators 9 corresponding to each comparator 31 generate test pattern signals of which pattern series change the same.

Each selector 8 selects one of a detection signal sampled by the sampling circuit 150 and a test pattern signal generated by the pattern generator 9 and inputs the selected signal to the corresponding SPAD addition circuit 151. Each selector 8 selects a detection signal sampled by the sampling circuit 150 at the time of performing a normal operation and selects a test pattern signal at the time of performing a malfunction diagnosis.

At the time of performing a malfunction diagnosis, for example, the same test pattern signal is input to each SPAD addition circuit 151, and the register blocks 33 respectively set the same calculation coefficients in the area calculation units 15-1 to 15-4. For this reason, the SPAD addition circuit 151, the histogram circuit 152, the filter circuit 153, and the echo detecting circuit 154 perform processes on the basis of a test pattern signal input to the SPAD addition circuit 151.

The malfunction detecting unit 4 includes two comparators 31 for the four area calculation units 15-1 to 15-4. Each comparator 31 compares output signals of two area calculation units that are different from each other at the time of performing a malfunction diagnosis. At the time of performing a malfunction diagnosis, when the same test pattern signal is input to the SPAD addition circuits 151, and the register blocks 33 set the same calculation coefficients in the area calculation units 15-1 to 15-4, in a case in which each SPAD addition circuit 151, each histogram circuit 152, each filter circuit 153, and each echo detecting circuit 154 are normally operated, output signals of the echo detecting circuits 154 are the same. Thus, each comparator 31 outputs a signal that indicates coincidence of a comparison result.

At the time of performing a malfunction diagnosis, in a case in which at least some of circuits inside one area calculation unit among two area calculation units input to the comparator 31 have a malfunction, output signals of these two area calculation units do not coincide with each other, and the comparator 31 outputs a signal indicating no coincidence of a comparison result. In accordance therewith, it can be determined that any one of the two area calculation units input to this comparator 31 has a malfunction.

A comparison result signal output from the comparator 31, for example, is output to the outside through the error output I/F 7 and the external output I/F 19. In accordance with the comparison result signal output from the comparator 31, it can be detected that any one of the area calculation units 15-1 to 15-4 inside the calculation unit 15 has a malfunction.

The control unit 5 performs switching of the selector 8. More specifically, the control unit 5 causes the selector 8 to select a detection signal output from the sampling circuit 150 at the time of performing a normal operation and causes the selector 8 to select a test pattern signal output from the pattern generator 9 at the time of performing a malfunction diagnosis.

The error output I/F 7 notifies of detection of a malfunction. In addition, by omitting the error output I/F 7, detection of a malfunction may be notified by the external output I/F 19. In a case in which a malfunction has been detected, for example, in accordance with an output signal from the error output I/F 7 or the external output I/F 19, an interrupt may be applied to a host processor not illustrated in the drawing. Alternatively, a host processor may detect a malfunction by regularly polling values of the error output I/F 7, the external output I/F 19, and various registers. Alternatively, information of presence/absence of a malfunction detection result may be added to data of a predetermined format (for example, MIPI: Mobile Industry Processor Interface, I2C: Inter-Integrated Circuits, SPI: Serial Peripheral Interface, or the like) output from the external output I/F 19.

In this way, the light detecting device 10 according to the first embodiment inputs respective two of output signals of the four area calculation units 15-1 to 15-4 inside the calculation unit 15 to mutually-different comparators 31 and inputs the same test pattern signal to the area calculation units 15-1 to 15-4 at the time of performing a malfunction diagnosis. In accordance with this, when at least a part of circuits inside a part of the area calculation units has a malfunction, non-coincidence is detected in a comparator 31 to which an output signal of an area calculation unit having the circuit having the malfunction is input. In accordance with this, depending on whether or not non-coincidence has been detected in any one comparator 31, it can be detected whether or not one of the four area calculation units 15-1 to 15-4 inside the calculation unit 15 has a malfunction.

In the light detecting device 10 illustrated in FIG. 16, although it can be known that one of the four area calculation units 15-1 to 15-4 inside the calculation unit 15 has had a malfunction, an area calculation unit that has had the malfunction cannot be identified. Thus, another mechanism for identifying an area calculation unit that has had a malfunction may be provided. For example, in a case in which non-coincidence of a comparison result has been detected in one comparator 31, a verification process in which certain data is written into a memory, which is not illustrated, inside the histogram circuit 152 inside two area calculation units connected to the comparator 31 and a memory, which is not illustrated in the drawing, inside the echo detecting circuit 154, and it is determined whether or not the written data can be normally read may be performed. In accordance with this, an area calculation unit of which the memory has had a malfunction can be identified.

In FIG. 16, although an example in which the SPAD array areas 0 to 3 (142-1 to 142-4), four sampling circuits 150, and the calculation unit 15 including the four area calculation units 15-1 to 15-4 are provided has been illustrated, the number of SPAD array areas does not necessarily need to be four. In a case in which n (here, n is an integer of two or more) SPAD array areas are present, n sampling circuits 150, a calculation unit 15 including n area calculation units 15-1 to 15-4, n pattern generators 9, and n selectors 8 are disposed. In a case in which n is an even number, n/2 comparators 31 are disposed. Also in each embodiment to be described below, although a value of n is arbitrary, in accordance with an embodiment to be described below, n may be an odd number or an even number.

### Second Embodiment

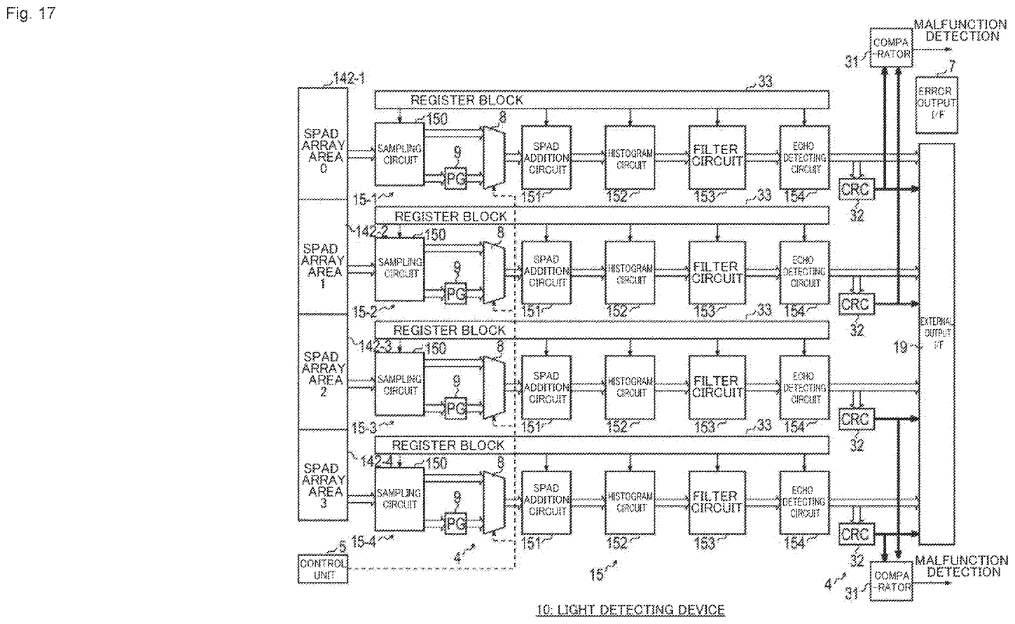

FIG. 17 is a block diagram of a light detecting device 10 according to a second embodiment. Hereinafter, different points from the light detecting device 10 illustrated in FIG. 16 will be focused in description.

The light detecting device 10 illustrated in FIG. 17 has a calculation unit 15 that has a configuration similar to that illustrated in FIG. 16. A malfunction detecting unit 4 illustrated in FIG. 17 includes an encoding unit 32 in addition to the internal components of the malfunction detecting unit 4 illustrated in FIG. 16. In other words, the malfunction detecting unit 4 illustrated in FIG. 17 includes four selectors 8 and four pattern generators 9 corresponding to four area calculation units 15-1 to 15-4, two comparators 31, and the encoding unit 32.

At the time of performing a malfunction diagnosis, the encoding unit 32 generates encoded data of output signals of corresponding area calculation units 15-1 to 15-4. The encoded data, for example, is a Cyclic Redundancy Check (CRC) signal. In the drawings of this application, the encoding unit 32 will be denoted by CRC 32. A CRC signal is generated by performing data compression of output signals of the area calculation units 15-1 to 15-4, and thus the number of stored bits can be reduced more than in a case in which the output signals of the area calculation units 15-1 to 15-4 are stored as they are. Thus, a cost at the time of storing output results of the area calculation units 15-1 to 15-4 can be reduced.

In a case in which a distance measuring system 1 including the light detecting device 10 according to this embodiment has the encoding unit 32 for communication already mounted therein, the encoding unit 32 can generate a CRC signal using the encoding unit 32, and thus there is no need to newly dispose an encoding unit 32.

The comparator 31 illustrated in FIG. 17 compares two CRC signals generated by two encoding units 32 As described above, the number of bits of a CRC signal is smaller than the number of bits of output signals of the area calculation units 15-1 to 15-4, and thus the internal configuration of the comparator 31 can be further simplified.

In this way, in the light detecting device 10 according to the second embodiment, encoded data acquired by encoding output signals of the area calculation units 15-1 to 15-4 is compared, and thus the configuration of the comparator 31 can be more simplified than in a case in which output signals of the area calculation units 15-1 to 15-4 are compared with each other, and thus the number of bits at the time of storing output results of the area calculation units 15-1 to 15-4 can be reduced.

### Third Embodiment

In the first and second embodiments described above, area calculation units 15-1 to 15-4 of an even number are disposed inside the calculation unit 15, the malfunction detecting unit 4 divides the even number of the area calculation units 15-1 to 15-4 into each set of two area calculation units, inputs the same test pattern signal to two area calculation units of each set and, in a case in which output signals of the two area calculation units are not the same, determines that any one of the two area calculation units has had a malfunction. In contrast to this, a third embodiment described below represents a case in which area calculation units 15-1 to 15-3 of an odd number are disposed inside a calculation unit 15. In addition, the odd number is not limited to three and may be an odd number of five or more.

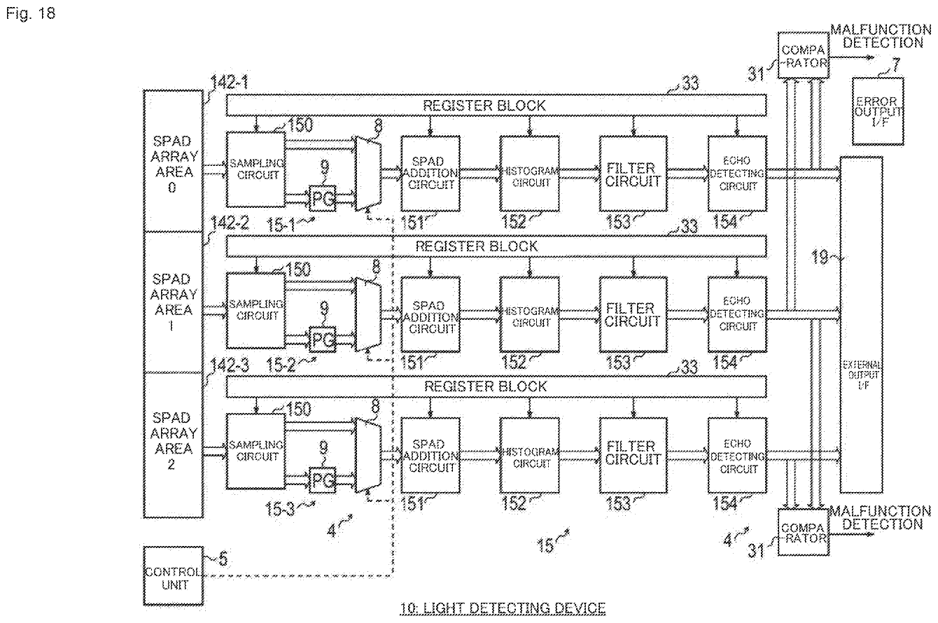

FIG. 18 is a block diagram of a light detecting device 10 according to a third embodiment. The light detecting device 10 illustrated in FIG. 18 includes SPAD array areas 0 to 2, a calculation unit 15 having three area calculation units 15-1 to 15-3, and a malfunction detecting unit 4.

The malfunction detecting unit 4 includes three pattern generators 9, three selectors 8, and two comparators 31. Each comparator 31 compares output signals of two area calculation units among three area calculation units 15-1 to 15-3 with each other. An output signal of one area calculation unit among the three area calculation units 15-1 to 15-3 is input to both the two comparators 31. Output signals of the remaining two area calculation units are input to one of the two comparators 31. In accordance with this, the two comparators 31 compare output signals of two area calculation units with each other using an output signal of one area calculation unit in a duplicated manner.

When non-coincidence of a comparison result is detected in at least one of the two comparators 31, it can be determined that one of area calculation units inside the calculation unit 15 has had a malfunction.

In addition, similar to FIG. 17, a plurality of encoding units 32 coding output signals of area calculation units 15-1 to 15-3 may be disposed in the light detecting device 10 illustrated in FIG. 18, and a plurality of pieces of encoded data may be input to the comparator 31.

In this way, in the third embodiment, although the area calculation units 15-1 to 15-3 of an odd number are disposed inside the calculation unit 15, by inputting output signals of some area calculation units to a plurality of comparators 31 in a duplicated manner, output signals of two area calculation units can be compared with each other by each comparator 31 by dividing all the area calculation units 15-1 to 15-3 inside the calculation unit 15 into each set of two area calculation units, and similar to the first and second embodiments, it can be detected that any one of the area calculation units 15-1 to 15-3 inside the calculation unit 15 has had a malfunction.

### Fourth Embodiment

In the light detecting devices 10 according to the first to third embodiments described above, although it can be known that any one of area calculation units inside the calculation unit 15 has had a malfunction, it cannot be identified which area calculation unit has had the malfunction by the malfunction detecting unit 4, and for the identification, as described above, a verification means or the like is necessary in addition to the malfunction detecting unit 4. A light detecting device 10 according to a fourth embodiment described below is configured to be able to identify an area calculation unit that has had a malfunction using a malfunction detecting unit 4.

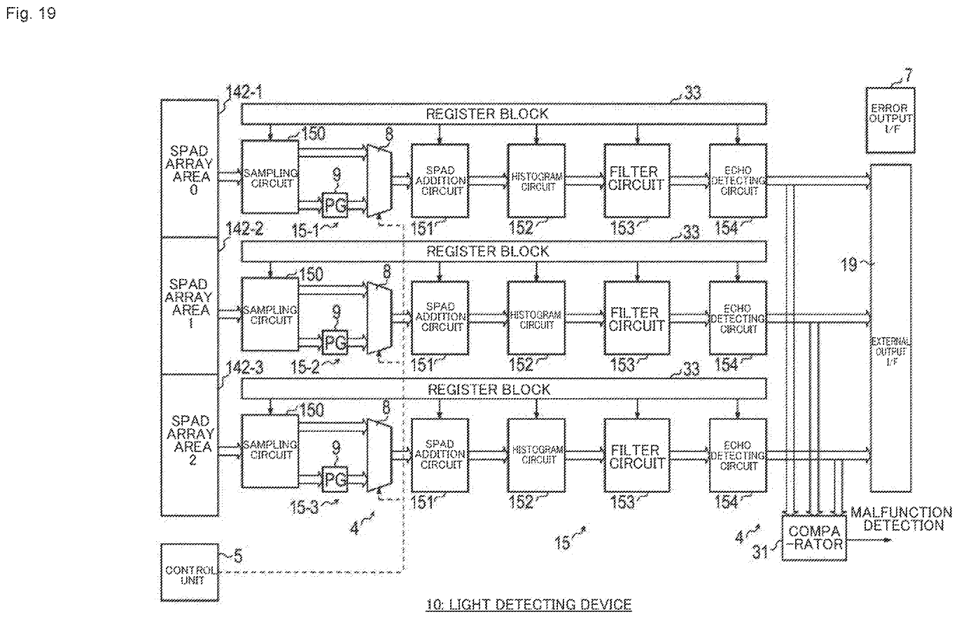

FIG. 19 is a block diagram of the light detecting device 10 according to the fourth embodiment. Hereinafter, different points from the light detecting device 10 illustrated in FIG. 16 will be focused in description. The light detecting device 10 illustrated in FIG. 19 includes SPAD array areas 0 to 2, a calculation unit 15 having three area calculation units 15-1 to 15-3, and a malfunction detecting unit 4.

The malfunction detecting unit 4 includes three pattern generators 9 and three selectors 8 corresponding to three area calculation units 15-1 to 15-3 and one comparator 31. Output signals of three area calculation units 15-1 to 15-3 are input to the comparator 31, and the comparator 31 compares these three output signals with each other. Then, in a case in which one output signal among the three output signals is different from the remaining two output signals, it can be identified that the area calculation unit that has output the one output signal has had a malfunction.

In this way, by comparing the three output signals that have been input with each other, the comparator 31 can identify an area calculation unit that has had a malfunction through a majority decision.

In FIG. 19, although output signals of three area calculation units 15-1 to 15-3 are input to the comparator 31, output signals of four or more area calculation units may be input to the comparator 31, and an area calculation unit that has had a malfunction can be identified through a majority decision. For example, in a case in which output signals of four area calculation units 15-1 to 15-4 are input to the comparator 31, in a case in which one output signal among them is different from the remaining three output signals, it can be identified that an area calculation unit that has output the one output signal has had a malfunction.

In addition, similar to FIG. 17, a plurality of encoding units 32 coding output signals of the area calculation units 15-1 to 15-3 may be disposed in the light detecting device 10 illustrated in FIG. 19, and a plurality of pieces of encoded data may be input to the comparator 31.

In this way, in the fourth embodiment, output signals of three or more area calculation units are input to the comparator 31, the output signals are compared with each other, and an area calculation unit that has had a malfunction is identified through a majority decision, whereby a malfunctioning place can be identified using a simple configuration.

### Fifth Embodiment

In a fifth embodiment, a malfunction diagnosis is individually performed on processing circuits of a plurality of stages inside area calculation units 15-1 to 15-4.

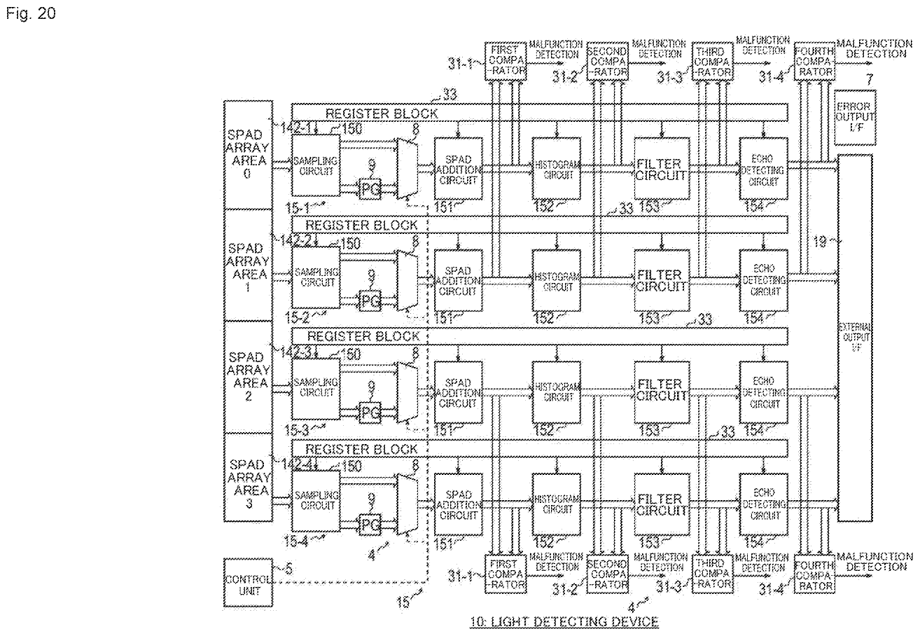

FIG. 20 is a block diagram of a light detecting device 10 according to the fifth embodiment. In the light detecting device 10 illustrated in FIG. 20, an internal configuration of a malfunction detecting unit 4 is different from that of the malfunction detecting unit 4 illustrated in FIG. 16. The malfunction detecting unit 4 illustrated in FIG. 20 includes a plurality of comparators 31 (first to fourth comparators 31-1 to 31-4) to which output signals of a plurality of stages of processing circuits inside the area calculation units 15-1 to 15-4 are input in addition to four pattern generators 9 and four selectors 8 corresponding to four area calculation units 15-1 to 15-4. Here, the processing circuits are sampling circuits 150, SPAD addition circuits 151, histogram circuits 152, filter circuits 153, and echo detecting circuits 154 inside the area calculation units 15-1 to 15-4.

In the example illustrated in FIG. 20, two of output signals of four SPAD addition circuits 151 inside the four area calculation units 15-1 to 15-4 are set as one set and are input to the two first comparators 31-1, and, in a case in which the output signals do not coincide with each other, it is detected that any one of the SPAD addition circuits 151 has had a malfunction. Similarly, two of output signals of four histogram circuits 152 inside the four area calculation units 15-1 to 15-4 are set as one set and are input to the two second comparators 31-2, and, in a case in which the output signals do not coincide with each other, it is detected that any one of the histogram circuits 152 has had a malfunction. Similarly, two of output signals of four filter circuits 153 inside the four area calculation units 15-1 to 15-4 are set as one set and are input to the two third comparators 31-3, and, in a case in which the output signals do not coincide with each other, it is detected that any one of the filter circuits 153 has had a malfunction. Similarly, two of output signals of four echo detecting circuits 154 inside the four area calculation units 15-1 to 15-4 are set as one set and are input to the two fourth comparators 31-4, and, in a case in which the output signals do not coincide with each other, it is detected that any one of the echo detecting circuits 154 has had a malfunction.

The malfunction detecting unit 4 illustrated in FIG. 20 includes a total of 8 comparators 31 (two of each of first to fourth comparators 31-1 to 31-4), and each comparator 31 can detect which processing circuit inside each of the area calculation units 15-1 to 15-4 has had a malfunction. An output signal of each comparator 31, for example, is output to the outside through the error output I/F 7 or the external output I/F 19.

Although the malfunction detecting unit 4 illustrated in FIG. 20 inputs two of output signals of processing circuits inside each of the area calculation units 15-1 to 15-4 to the first to fourth comparators 31-1 to 31-4, similar to FIG. 19, three or more output signals of each processing circuit may be input to the comparator 31, and it may be configured to be able to identify which processing circuit has had a malfunction through a majority decision.

In addition, similar to FIG. 17, encoded data acquired by coding output signals of processing circuits may be input to the comparator 31.

In this way, in the fifth embodiment, output signals of processing circuits of each stage inside a plurality of the area calculation units 15-1 to 15-4 are compared by corresponding comparators 31 (the first to fourth comparators 31-1 to 31-4), and thus it can be detected which processing circuit inside the area calculation units 15-1 to 15-4 has had a malfunction.

### Sixth Embodiment

In a sixth embodiment, a test pattern signal is input to a plurality of places inside a sampling circuit 150 and a calculation circuit, and malfunction detection is performed at the plurality of places.

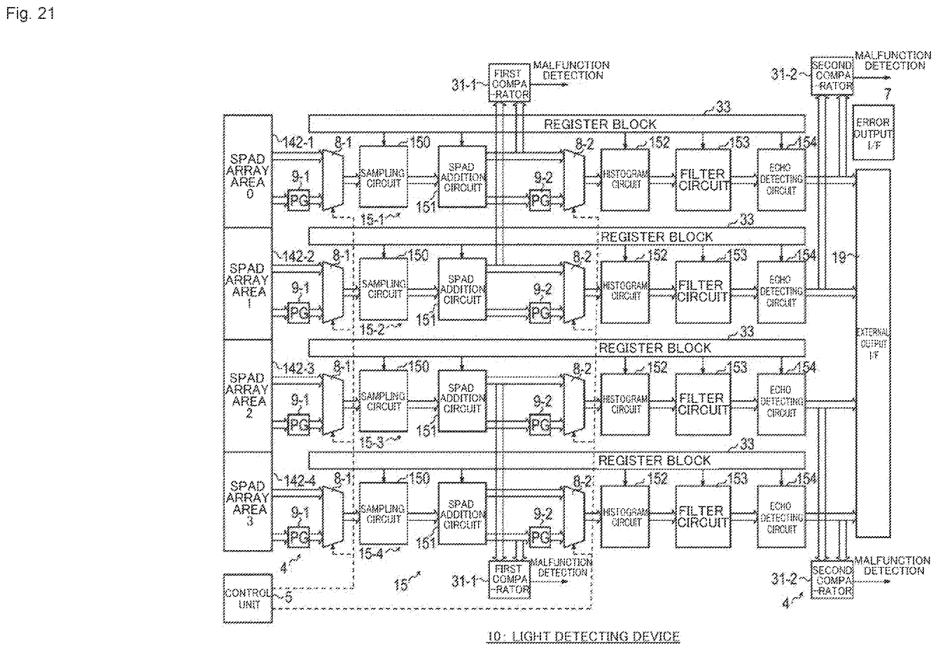

FIG. 21 is a block diagram of a light detecting device 10 according to the sixth embodiment. In the light detecting device 10 illustrated in FIG. 21, the internal configuration of a malfunction detecting unit 4 is different from that of the malfunction detecting unit 4 illustrated in FIG. 16. The malfunction detecting unit 4 illustrated in FIG. 21 includes four first pattern generators 9-1 and four first selectors 8-1 disposed between SPAD array areas 0 to 3 (142-1 to 142-4) and four sampling circuits 150, two first comparators 31-1 to which two of output signals of four SPAD adders are input as one set, four second pattern generators 9-2 and four second selectors 8-2 disposed between the four SPAD adders and four histogram circuits 152, and two second comparators 31-2 to which two of output signals of the four echo detecting circuits 154 are input as one set.

The four first pattern generators 9-1, the four first selectors 8-1, and the two first comparators 31-1 are used for detecting a malfunction of any one of the four sampling circuits 150 and the four SPAD addition circuits 151 at the time of a test mode. When non-coincidence of output signals is detected in at least one of the two first comparators 31-1, it is detected that any one of the four sampling circuits 150 and the four SPAD addition circuits 151 has had a malfunction. Four test patterns generated by the four first pattern generators 9-1 are random patterns generated using pseudo random numbers or the like, two test patterns corresponding to the two first comparators 31-1 are patterns in which a pattern series changes the same.

The four second pattern generators 9-2, the four second selectors 8-2, and the two second comparators 31-2 are used for detecting a malfunction of any one of the four histogram circuits 152, the four filter circuits 153, the four echo detecting circuits 154 at the time of a test mode. When non-coincidence of output signals is detected in at least one of the two second comparators 31-2, it is detected that any one of the four histogram circuits 152, the four filter circuits 153, and the four echo detecting circuits 154 has had a malfunction. Four test patterns generated by the four second pattern generators 9-2 are random patterns generated using pseudo random numbers or the like, and two test patterns corresponding to the two second comparators 31-2 are patterns in which a pattern series changes the same.

At the time of performing a malfunction diagnosis, a control unit 5 selects one of a first malfunction diagnosis mode and a second malfunction diagnosis mode. When the first malfunction diagnosis mode is selected by the control unit 5, the first selector 8-1 selects a first test pattern and inputs the selected first test pattern to the sampling circuit 150. In this case, processes of the sampling circuit 150 and the SPAD addition circuits 151 are sequentially performed on the basis of the first test pattern, and two of output signals of the four SPAD addition circuits 151 are input to the two first comparators 31-1 as one set. In accordance with this, when the first malfunction diagnosis mode is selected, the two first comparators 31-1 can detect a malfunction of any one of the four sampling circuits 150 or the four SPAD addition circuits 151.

When the second malfunction diagnosis mode is selected by the control unit 5, the second selector 8-2 selects a second test pattern and inputs the selected second test pattern to the histogram circuits 152. In this case, processes of the histogram circuit 152, the filter circuit 153, and the echo detecting circuit 154 are sequentially performed on the basis of the second test pattern, and two of output signals of the four echo detecting circuits 154 are input to the two second comparators 31-2 as one set. In accordance with this, when the second malfunction diagnosis mode is selected, the two second comparators 31-2 can detect a malfunction of any one of the four histogram circuits 152, the four filter circuits 153, or the four echo detecting circuits 154.

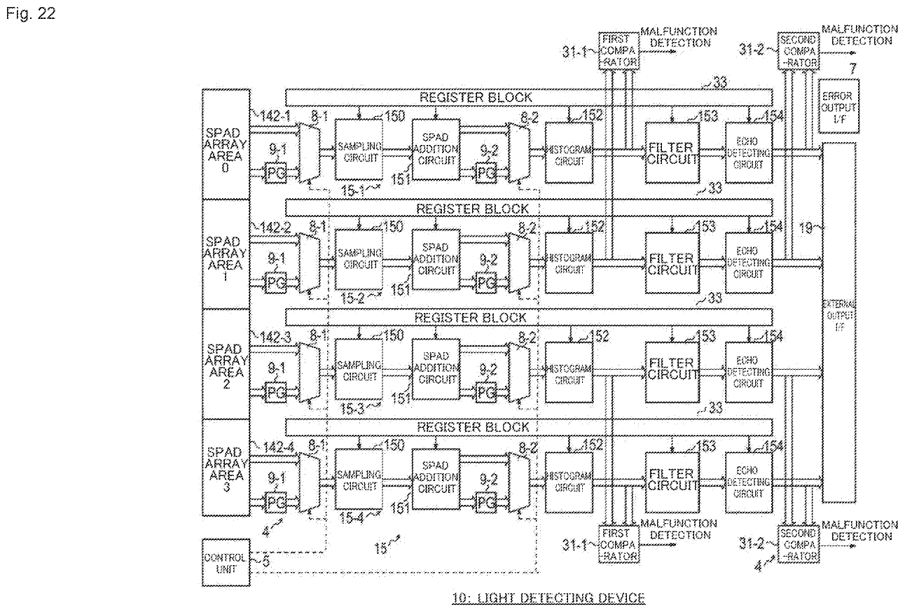

FIG. 22 is a block diagram of a light detecting device 10 according to a modified example of FIG. 21. In FIG. 22, two first comparators 31-1 are disposed at places different from those illustrated in FIG. 21. Two of output signals of the histogram circuits 152 are input to the two first comparators 31-1 illustrated in FIG. 22 as one set.

At the time of performing a malfunction diagnosis, the control unit 5 selects one of the first malfunction diagnosis mode and the second malfunction diagnosis mode. When the first malfunction diagnosis mode is selected by the control unit 5, the first selector 8-1 selects the first test pattern and inputs the selected first test pattern to the sampling circuit 150. In this case, on the basis of the first test pattern, processes of the sampling circuit 150, the SPAD addition circuit 151, and the histogram circuit 152 are sequentially performed, and two of output signals of the four histogram circuits 152 are input to the two first comparator 31-1 as one set. In accordance with this, when the first malfunction diagnosis mode is selected, the two first comparators 31-1 can detect that any one of the four sampling circuits 150, the four SPAD addition circuits 151, or the four histogram circuits 152 has had a malfunction.

When the second malfunction diagnosis mode is selected by the control unit 5, the second selector 8-2 selects the second test pattern and inputs the selected second test pattern to the histogram circuit 152. In this case, on the basis of the second test pattern, processes of the histogram circuit 152, the filter circuit 153, and the echo detecting circuit 154 are sequentially performed, and two of output signals of the four echo detecting circuits 154 are input to the two second comparator 31-2 as one set. In accordance with this, when the second malfunction diagnosis mode is selected, the two second comparators 31-2 can detect that any one of the four histogram circuits 152, the four filter circuits 153, or the four echo detecting circuits 154 has had a malfunction.

Also in the light detecting devices 10 illustrated in FIGS. 21 and 22, three or more output signals may be input to one first comparator 31-1 or the second comparator 31-2, and a malfunctioning processing circuit may be identified through a majority decision.

In addition, similar to FIG. 17, encoded data acquired by coding an output signal of each processing circuit may be input to the comparator 31.

In this way, in the sixth embodiment, test patterns are input to a plurality of places inside the light detecting device 10, and output signals of processing circuits of different stages among processing circuits of a plurality of stages inside each of the area calculation units 15-1 to 15-4 are input to individual comparators 31, whereby it becomes easy to identify a place inside the light detecting device 10 at which a malfunction has occurred.

### Seventh Embodiment

A light detecting device 10 according to a seventh embodiment represents a case in which the number of pixels inside a SPAD array 141 is larger than the number of pixels that can be processed by a calculation unit 15.

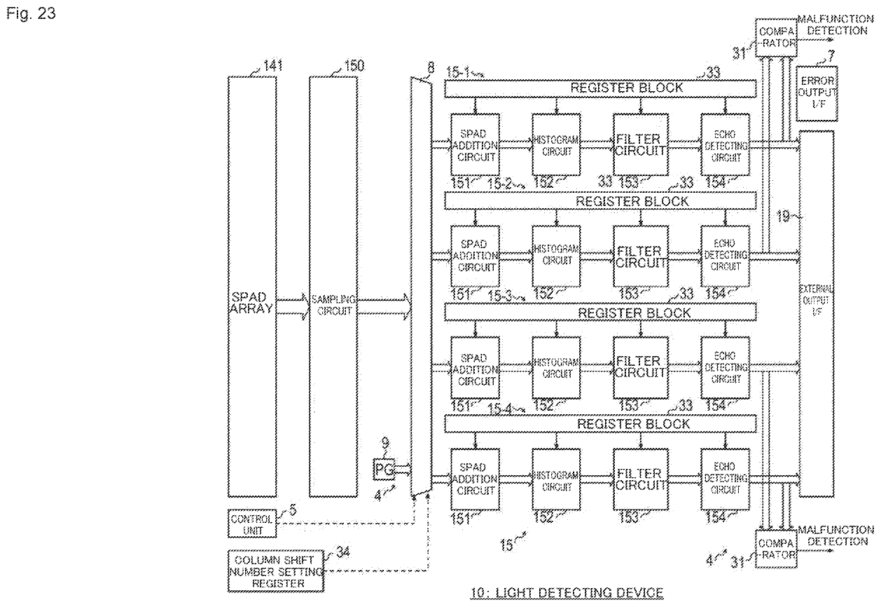

FIG. 23 is a block diagram of the light detecting device 10 according to the seventh embodiment. The light detecting device 10 illustrated in FIG. 23 includes: a SPAD array 141, a sampling circuit 150, a selector 8, a column shift number setting register 34, a calculation unit 15 including four area calculation units 15-1 to 15-4, and a malfunction detecting unit 4. The malfunction detecting unit 4 includes a pattern generator 9 and two comparators 31.

In this embodiment, a case in which the number of pixels inside the SPAD array 141 is larger than the number of pixels that can be processed by the calculation unit 15 is assumed, and a distance measuring process is performed by the calculation unit 15 for each pixel group of a column direction inside the SPAD array 141.

The sampling circuit 150 outputs detection signals corresponding to the number of pixels inside the SPAD array 141. A detection signal output from the sampling circuit 150 is shifted by a column number set in the column shift number setting register 34 and is output from the selector 8 at the time of a normal operation. In this way, a detection signal corresponding to each pixel inside some columns inside the SPAD array 141 is selected by the selector 8 and is supplied to the calculation unit 15.

The selector 8 is disposed between the sampling circuit 150 and four SPAD adders. At the time of a normal operation, the selector 8 performs column shift on a detection signal output from the sampling circuit 150 as described above and then supplies the detection signals to each SPAD addition circuit 151.

On the other hand, at the time of performing a malfunction diagnosis, the selector 8 selects a test pattern signal generated by the pattern generator 9 and supplies the selected test pattern signal to each SPAD addition circuit 151 inside the calculation unit 15 without performing an operation of shifting each column (hereinafter, referred to as column shift).

Similar to FIG. 16, the calculation unit 15 includes four area calculation units 15-1 to 15-4, and each of the area calculation units 15-1 to 15-4 includes a SPAD addition circuit 151, a histogram circuit 152, a filter circuit 153, and an echo detecting circuit 154. Two of output signals of four echo detecting circuits 154 are input to two comparators 31 as one set. A comparison operation performed by the comparator 31 is similar to that illustrated in FIG. 16.

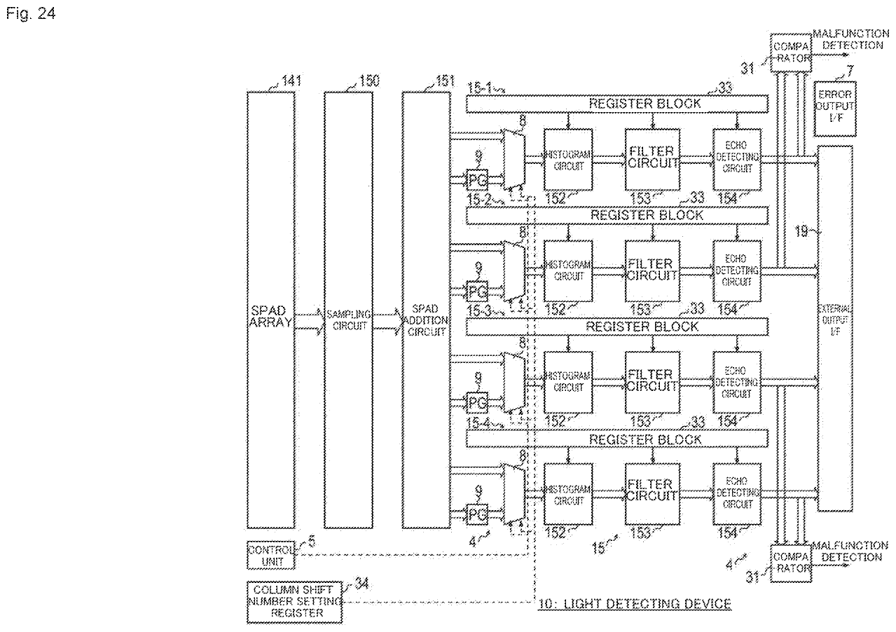

FIG. 24 is a block diagram of a light detecting device 10 according to a modified example of FIG. 23. In the light detecting device 10 illustrated in FIG. 24, a SPAD addition circuit 151 detects pixel values of all the pixels inside a SPAD array 141. A histogram circuit 152, a filter circuit 153, and an echo detecting circuit 154 on a later stage side of the SPAD addition circuit 151 can process pixels corresponding to a number that is smaller than the number of pixels inside the SPAD array 141.

A pixel value output from the SPAD addition circuit 151 is column-shifted and then is input to each histogram circuit 152.

Four selectors 8 inside the light detecting device 10 illustrated in FIG. 24 are disposed between four SPAD addition circuits 151 and four histogram circuits 152. At the time of a normal operation, as described above, each selector 8 performs column shift of a pixel value output from each SPAD addition circuit 151 and then supplies the column-shifter pixel value to a corresponding histogram processing unit. On the other hand, at the time of performing a malfunction diagnosis, each selector 8 selects a test pattern signal generated by the pattern generator 9 and inputs the selected test pattern signal to a corresponding histogram circuit 152.

Also in the light detecting devices 10 illustrated in FIGS. 23 and 24, three or more output signals may be input to one first comparator 31-1 or the second comparator 31-2, and a malfunctioning processing circuit may be identified through a majority decision.

In addition, similar to FIG. 17, encoded data acquired by coding an output signal of each processing circuit may be input to the comparator 31.

In this way, even in a case in which the number of pixels of the SPAD array 141 is larger than the number of pixels of each processing circuit inside the calculation unit 15, the light detecting device 10 according to the seventh embodiment can perform a malfunction diagnosis by inputting a test pattern signal to each processing circuit at the time of performing the malfunction diagnosis.

### Eighth Embodiment

In an eighth embodiment, a register block 33 storing calculation coefficients used when processing circuits inside area calculation units 15-1 to 15-4 perform calculation processes stores calculation coefficients for a malfunction diagnosis.

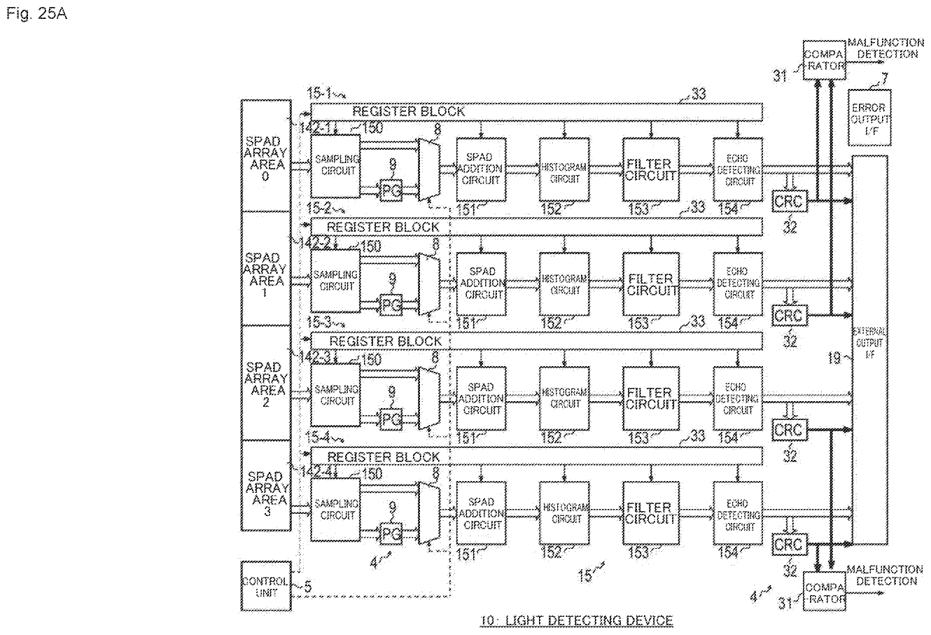

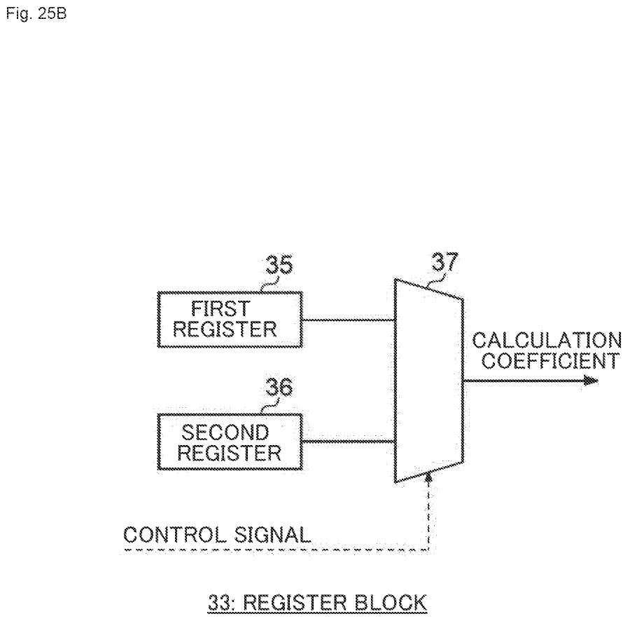

FIG. 25A is a block diagram of a light detecting device 10 according to the eighth embodiment. FIG. 25A illustrates a configuration similar to that of the light detecting device 10 illustrated in FIG. 17. More specifically, a malfunction detecting unit 4 illustrated in FIG. 25A, similar to the light detecting device 10 illustrated in FIG. 17, includes four pattern generators 9, four selectors 8, and four encoding units (CRC) 32 corresponding to four area calculation units 15-1 to 15-4 and two comparators 31. In addition, the light detecting device 10 illustrated in FIG. 25A includes a control unit 5. At the time of a normal operation or at the time of a malfunction diagnosis, the control unit 5 performs switching of the selector 8 and switching of calculation coefficients inside the register block 33. The encoding unit 32 generates encoded data acquired by coding an output signal of the echo detecting circuit 154. The encoded data, for example, is a CRC signal. In addition, the encoding unit 32 may generate encoded data other than a CRC signal.

FIG. 25B is a block diagram illustrating an internal configuration of the register block (a calculation coefficient storing unit) 33. As illustrated in FIG. 25B, the register block 33 includes a first register 35 that stores calculation coefficients for a normal operation (first calculation coefficients), a second register 36 that stores calculation coefficients at the time of a malfunction diagnosis (second calculation coefficients), and a selector 37 that selects one of the calculation coefficient stored in the first register 35 and a calculation coefficient stored in the second register 36 on the basis of a control signal from the control unit 5.

The register block 33 is disposed for each of the area calculation units 15-1 to 15-4, and the second register 36 is disposed in each register block 33, and thus calculation coefficients at the time of a malfunction diagnosis can be individually set for each of the area calculation units 15-1 to 15-4.

In addition, the light detecting device 10 according to the eighth embodiment can be combined with the light detecting devices 10 according to the first to seventh embodiments described above, and thus configurations other than the register block 33 and the control unit 5 inside the light detecting device 10 may be the same as those of the light detecting devices 10 according to the second to seventh embodiments.

Also in the light detecting device 10 illustrated in FIG. 25A, three or more output signals may be input to one first comparator 31-1 or the second comparator 31-2, and a malfunctioning processing circuit may be identified through a majority decision.

In addition, similar to FIG. 17, encoded data acquired by coding an output signal of each processing circuit may be input to the comparator 31.

In this way, in the eighth embodiment, the calculation coefficients for a normal operation and the calculation coefficients for a malfunction diagnosis are stored in the register block 33, and, in accordance with an instruction from the control unit 5, one of the calculation coefficients is selected and is supplied to each of the area calculation units 15-1 to 15-4. In accordance with this, after calculation coefficients that are appropriate at the time of performing a malfunction diagnosis are set in each of the area calculation units 15-1 to 15-4, by inputting a test pattern, a malfunction diagnosis can be performed. In addition, in the eighth embodiment, not only at the time of a normal operation but also at the time of a malfunction diagnosis, individual calculation coefficients can be set in each of the area calculation units 15-1 to 15-4.

### Ninth Embodiment

At the time of performing a malfunction diagnosis, test pattern signals changing in the same pattern series are assumed to be input to a plurality of the area calculation units 15-1 to 15-4. For this reason, it is assumed that the calculation coefficients set in the area calculation units 15-1 to 15-4 at the time of performing a malfunction diagnosis may be configured to be the same without incurring any problem. Thus, in a ninth embodiment described below, at the time of performing a malfunction diagnosis, the same calculation coefficients are set in a plurality of area calculation units 15-1 to 15-4.

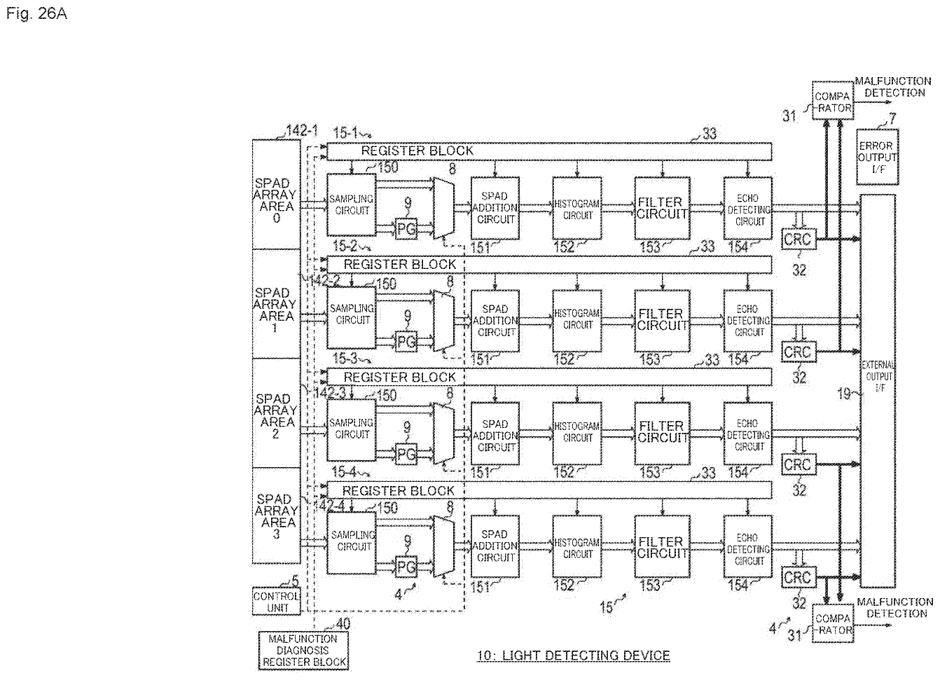

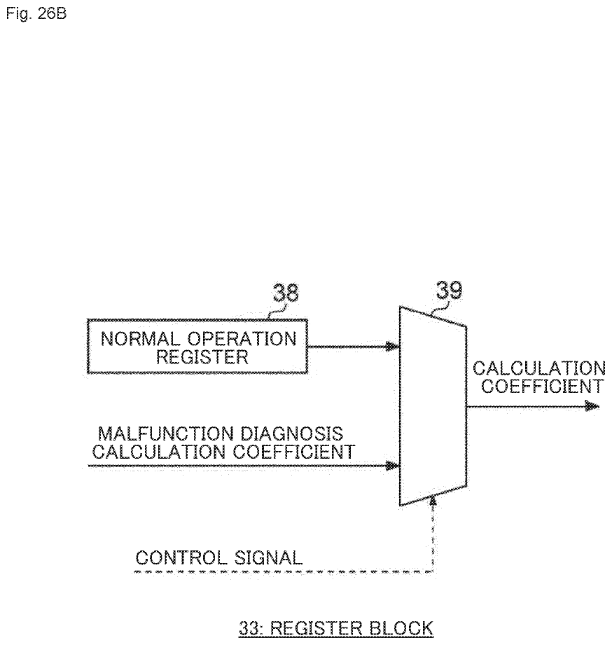

FIG. 26A is a block diagram of a light detecting device 10 according to the ninth embodiment, and FIG. 26B is a block diagram illustrating an internal configuration of a register block 33 disposed in each of area calculation units 15-1 to 15-4. Hereinafter, different points from the light detecting devices 10 illustrated in FIGS. 25A and 25B will be focused in description.

The internal configuration of the register block 33 illustrated in FIG. 26B is different from that of the register block 33 illustrated in FIG. 25B. The register block 33 illustrated in FIG. 26B includes a normal operation register (a first calculation coefficient storing unit) 38 storing calculation coefficients for a normal operation and a selector 39.

In addition, the light detecting device 10 according to the ninth embodiment includes a malfunction diagnosis register block (a second calculation coefficient storing unit) 40 in addition to the register block 33 for each of the area calculation units 15-1 to 15-4. One malfunction diagnosis register block 40 is disposed for a plurality of the area calculation units 15-1 to 15-4.

At the time of a normal operation and at the time of a malfunction diagnosis, the control unit 5 controls selection of the selector 39 inside the register block 33 for each of the area calculation units 15-1 to 15-4. In accordance with this, the selector 39 selects calculation coefficients stored in the normal operation register 38 at the time of a normal operation and selects calculation coefficients stored in the malfunction diagnosis register block 40 at the time of a malfunction diagnosis.

Also in the light detecting device 10 illustrated in FIG. 26A, three or more output signals may be input to one first comparator 31-1 or the second comparator 31-2, and a malfunctioning processing circuit may be identified through a majority decision.

In addition, similar to FIG. 17, encoded data acquired by coding an output signal of each processing circuit may be input to the comparator 31.

In this way, in the light detecting device 10 according to the ninth embodiment, at the time of performing a malfunction diagnosis, a test pattern signal is input after common calculation coefficients are set in a plurality of area calculation units 15-1 to 15-4, and thus the internal configuration of the register block 33 disposed in each of the area calculation units 15-1 to 15-4 can be simplified.

### Tenth Embodiment

In a light detecting device 10 according to a tenth embodiment, a normal operation period and a malfunction diagnosis period are completely separated from each other. The light detecting device 10 according to the tenth embodiment can be combined with the light detecting devices 10 according to the first to ninth embodiments described above and thus has an internal configuration according to the light detecting device 10 according to any one of the first to ninth embodiments.

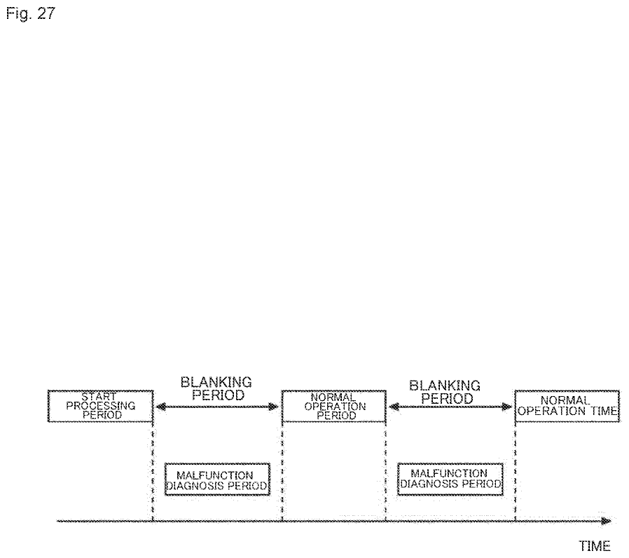

FIG. 27 is an operation timing diagram of the light detecting device 10 according to the tenth embodiment. As illustrated in the drawing, in a blanking period between a start processing period and a normal operation period in which distance measurement is performed, a malfunction diagnosis period is provided. In the malfunction diagnosis period, a process of distance measurement in the light detecting device 10 is stopped. In other words, in the malfunction diagnosis period, a light receiving operation using the SPAD array 141 and a sampling operation using the sampling circuit 150 are stopped, and each of the area calculation units 15-1 to 15-4 inside the calculation unit 15 operates each processing circuit on the basis of a test pattern signal generated by the pattern generator 9.

The period control illustrated in FIG. 27, for example, is performed by the control unit (a timing control unit) 5. The control unit 5 according to the tenth embodiment controls the SPAD array 141 and the calculation unit 15 separately in a normal operation period in which a histogram is generated on the basis of light received by the SPAD array 141 and in a malfunction diagnosis period in which malfunction detection of the calculation unit 15 is performed on the basis of a test pattern signal in a state in which the light receiving operation of the SPAD array 141 is stopped.

In this way, in the tenth embodiment, a malfunction diagnosis is performed in a state in which a processing operation in the normal operation period is stopped, and thus a malfunction diagnosis of each of the area calculation units 15-1 to 15-4 can be performed without any influence on the processing operation within the normal operation period.

### (11th Embodiment)

A light detecting device 10 according to the 11th embodiment performs a malfunction diagnosis until next light is received after a SPAD array 141 receives light. The light detecting device 10 according to the 11th embodiment can be combined with the light detecting devices 10 according to the first to ninth embodiments described above, and thus the internal configuration of the light detecting device 10 is in accordance with that of the light detecting device 10 according to any one of the first to ninth embodiments.

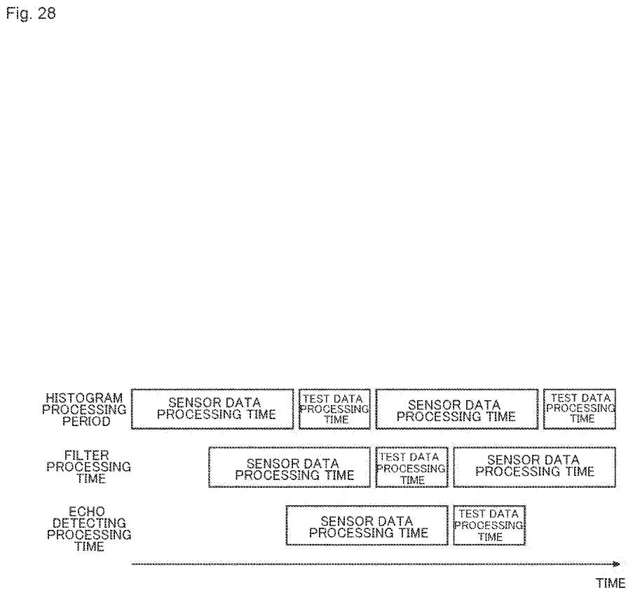

FIG. 28 is an operation timing diagram of the light detecting device 10 according to the 11th embodiment. A light emitting unit inside a distance measuring system 1 intermittently emits laser light for every predetermined period. Thus, the SPAD array 141 intermittently receives reflective light from an object in accordance with a light emission timing of the light emitting unit. A timing at which reflective light is received changes in accordance with a distance to an object, and thus a period in which the SPAD array 141 receives light and performs distance measurement (hereinafter, referred to as a sensor data processing period) has a predetermined time width. The SPAD array 141 has a plurality of sensor data processing periods in accordance with a timing at which the light emitting unit intermittently emits light, and between individual sensor data processing periods, a period in which the SPAD array 141 does not receive light (hereinafter, referred to as a non-light reception period or a test data processing period) is present. Thus, in the 11th embodiment, a malfunction diagnosis is performed within the non-light reception period (the test data processing period).

FIG. 28 illustrates a sensor data processing period in which the histogram circuit 152 performs a histogram generating process, a sensor data processing period in which the filter circuit 153 performs a noise eliminating process, and a sensor data processing period in which the echo detecting circuit 154 performs distance measurement. After the process of the histogram circuit 152 ends, the process of the filter circuit 153 is performed, and thereafter, the process of the echo detecting circuit 154 is performed, and thus, the processes of the histogram circuit 152, the filter circuit 153, and the echo detecting circuit 154 at the time of performing a normal operation are performed with being shifted in time. In the 11th embodiment, between such processes, a test pattern for a malfunction diagnosis is input, the processing of the test pattern is performed in order of the histogram circuit 152, the filter circuit 153, and the echo detecting circuit 154.

The period control illustrated in FIG. 28, for example, is performed by the control unit (the timing control unit) 5. The control unit 5 according to the 11th embodiment performs control for inputting a test pattern signal to an input node or an internal node of the calculation unit 15 between periods in which each processing circuit inside the calculation unit 15 performs a process on the basis of light received by the SPAD array 141 and outputting a malfunction diagnosis signal from the calculation unit 15.

According to the 11th embodiment, a malfunction diagnosis is performed between processes of a pipeline without stopping the process of the pipeline of a normal operation, and thus a malfunction diagnosis and malfunction detection of the calculation unit 15 can be performed without degrading distance measurement accuracy and rapidity.

### (Operations and Effects of 1st to 11th Embodiments)

In the 1st to 11th embodiments, a malfunction diagnosis and malfunction detection can be performed without providing a physically redundant circuit, and thus a malfunction diagnosis and malfunction detection can be performed without increasing the circuit scale of the light detecting device 10 and increasing the power consumption thereof.

In addition, in the 1st to 11th embodiments, a comparison between an output signal at the time of inputting a test pattern signal and an output expected value prepared in advance is not performed, and thus a storage unit for storing the output expected value is not required.

Furthermore, in the 1st to 11th embodiments, the malfunction detecting unit 4 can be added with hardly changing the block configuration of the light detecting device 10, and thus the malfunction detecting unit 4 can be added to a light detecting device 10 having various internal configurations as post-installation.

In addition, in the 1st to 11th embodiments, without duplexing each processing circuit inside the light detecting circuit, a malfunction detection rate equivalent to that of a case in which duplexing is implemented can be acquired.

In this way, although the light detecting devices 10 according to the 1st to 11th embodiments have various technical effects described above, in the light detecting device 10 including the histogram circuit 152 and the echo detecting circuit 154, there is no light detecting device 10 having a malfunction detecting function in the future, and thus configurations as below may be considered.

### 12th Embodiment

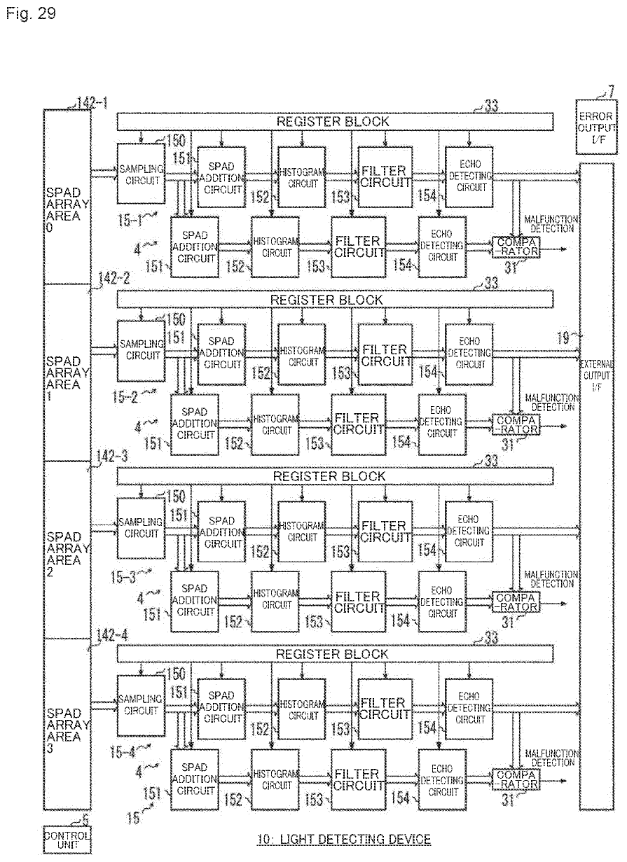

FIG. 29 is a block diagram of a light detecting device 10 according to a 12th embodiment. In the light detecting device 10 illustrated in FIG. 29, the internal configuration of each of area calculation units 15-1 to 15-4 inside a calculation unit 15 are duplexed. More specifically, the light detecting device 10 illustrated in FIG. 29 includes a malfunction detecting unit 4 for each of the area calculation units 15-1 to 15-4, and, in the malfunction detecting unit 4, processing circuits having the same configurations as those of the area calculation units 15-1 to 15-4 are included. In other words, a SPAD addition circuit 151, a histogram circuit 152, a filter circuit 153, and an echo detecting circuit 154 inside the area calculation units 15-1 to 15-4 are disposed also in the malfunction detecting unit 4. Hereinafter, the SPAD addition circuit 151, the histogram circuit 152, the filter circuit 153, and the echo detecting circuit 154 inside the area calculation units 15-1 to 15-4 will be referred to as first area calculation units 15-1 to 15-4, and the SPAD addition circuit 151, the histogram circuit 152, the filter circuit 153, and the echo detecting circuit 154 inside the malfunction detecting unit 4 will be referred to as second area calculation units 15-1 to 15-4. In each processing circuit inside the second area calculation units 15-1 to 15-4 inside the malfunction detecting unit 4, calculation coefficients at the time of a malfunction diagnosis are set from a corresponding register block 33.

The comparator 31 disposed for each of the area calculation units 15-1 to 15-4 compares an output signal of a corresponding one of the first area calculation units 15-1 to 15-4 with an output signal of a corresponding one of the second area calculation units 15-1 to 15-4 and outputs a comparison result signal. The comparison result signals are signals indicating whether or not any one of the first area calculation units 15-1 to 15-4 and the second area calculation units 15-1 to 15-4 has had a malfunction. The comparison result signals output from four comparators 31 corresponding to the four area calculation units 15-1 to 15-4 are output to the outside through the error output I/F 7.

Similar to the first area calculation units 15-1 to 15-4, a detection signal output from the sampling circuit 150 is input to the second area calculation units 15-1 to 15-4 inside the malfunction detecting unit 4. For this reason, without using a test pattern, malfunction detection can be constantly performed by the comparator 31 using a detection signal output from the sampling circuit 150 during a normal operation period.

In the light detecting device 10 according to the 12th embodiment, the internal configuration of a plurality of the area calculation units 15-1 to 15-4 inside the calculation unit 15 is duplexed, and thus although there is a problem in that the circuit scale of the light detecting device 10 becomes large, malfunction detection can be performed by the comparator 31 continuously during a normal operation period without inputting a test pattern signal from the outside.

### 13th Embodiment

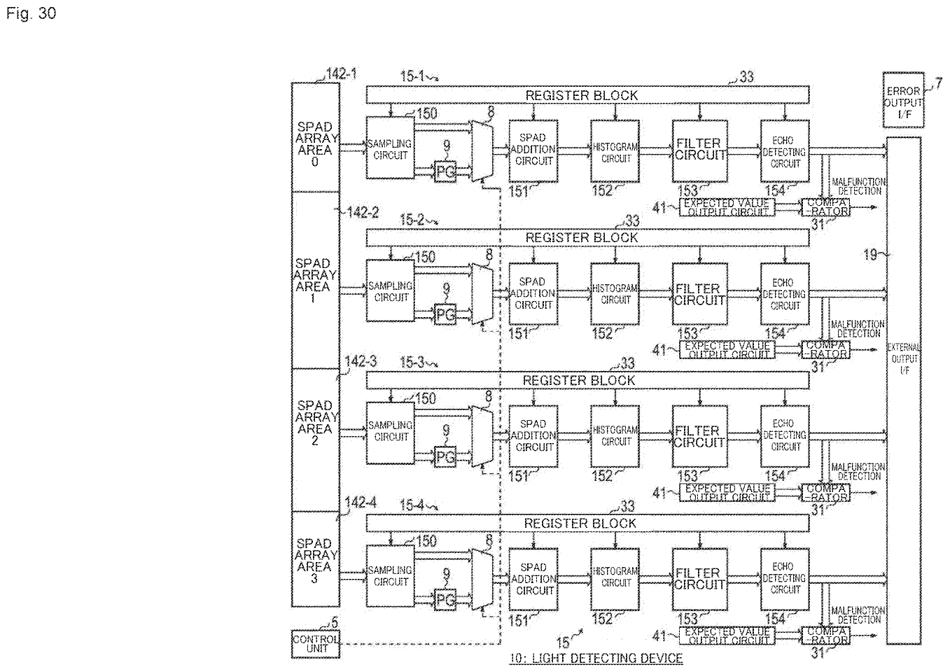

FIG. 30 is a block diagram of a light detecting device 10 according to a 13th embodiment. Hereinafter, different points from the light detecting device 10 illustrated in FIG. 16 will be focused in description.

The light detecting device 10 illustrated in FIG. 30 includes a pattern generator 9, a selector 8, an expected value output circuit 41, and a comparator 31 for each of the area calculation units 15-1 to 15-4 inside the calculation unit 15. The expected value output circuit 41 stores expected values representing assumed output signals output from the area calculation units 15-1 to 15-4 when a test pattern signal generated by the pattern generator 9 is input to the SPAD addition circuit 151 inside the area calculation units 15-1 to 15-4 in advance.

At the time of performing a malfunction diagnosis, each selector 8 selects a test pattern signal and inputs the selected test pattern signal to the SPAD addition circuit 151. Each of the area calculation units 15-1 to 15-4 sequentially processes test pattern signals, and an output signal of the echo detecting circuit 154 that is a final stage is input to the comparator 31. The comparator 31 compares an output signal of the echo detecting circuit 154 with an expected value output from the expected value output circuit 41 and, in the case of non-coincidence, determines that a corresponding one of area calculation units 15-1 to 15-4 has had a malfunction.

In this way, the light detecting device 10 according to the 13th embodiment has the expected value output circuit 41 for each of the area calculation units 15-1 to 15-4, and the circuit scale becomes large. On the other hand, the output signal of each of the area calculation units 15-1 to 15-4 and the expected value are compared by the comparator 31, and thus, in the case of non-coincidence with the expected value, it can be identified that a corresponding one of the area calculation units 15-1 to 15-4 has had a malfunction.

### Application Example

The technique according to the present disclosure can be applied to various products. For example, the technique according to the present disclosure may be implemented as an apparatus mounted on any kind of mobile body such as an automobile, an electric vehicle, a hybrid electric vehicle, a motorcycle, a bicycle, a personal mobility, an airplane, a drone, a ship, a robot, a construction machine, or an agricultural machine (tractor).

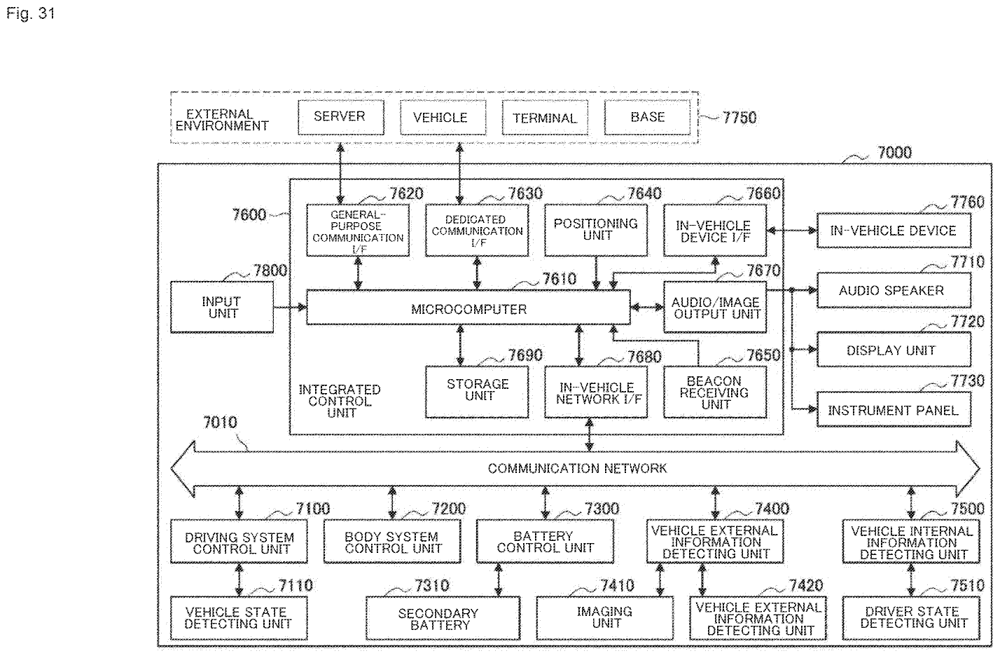

FIG. 31 is a block diagram illustrating an example of an overall configuration of a vehicle control system 7000 that is one example of a mobile body control system to which the technology according to the present disclosure is applied. The vehicle control system 7000 includes a plurality of electronic control units connected through a communication network 7010. In the example, illustrated in FIG. 31, the vehicle control system 7000 includes a driving system control unit 7100, a body system control unit 7200, a battery control unit 7300, a vehicle external information detecting unit 7400, a vehicle internal information detecting unit 7500, and an integrated control unit 7600. The communication network 7010 connecting such a plurality of control units, for example, may be an in-vehicle communication network compliant with an arbitrary specification such as a Controller Area Network (CAN), a Local Interconnect Network (LIN), a Local area Network (LAN), FlexRay (registered trademark), or the like.

Each control unit includes a microcomputer that performs arithmetic processing according to various programs, a storage unit that stores programs executed by the microcomputer, parameters used for various arithmetic operations, and the like, and a driving circuit that drives various control target devices. Each control unit includes a network I/F for performing communication with other control units via the communication network 7010, and includes a communication I/F for performing communication through wired communication or wireless communication with devices, sensors, or the like inside or outside the vehicle. In FIG. 31, a microcomputer 7610, a general-purpose communication I/F 7620, a dedicated communication I/F 7630, a positioning unit 7640, a beacon reception unit 7650, an in-vehicle device I/F 7660, an audio/image output unit 7670, a vehicle-mounted network I/F 7680, and a storage unit 7690 are shown as functional configurations of the integrated control unit 7600. The other control units also include a microcomputer, a communication I/F, a storage unit, and the like.

For example, the driving system control unit 7100 controls operations of devices relating to a driving system of a vehicle in accordance with various programs. For example, the driving system control unit 7100 functions as control devices such as a driving force generation device for generating driving force for the vehicle such as an internal combustion engine or a driving motor, a driving force transmission mechanism for transmitting a driving force to vehicle wheels, a steering mechanism for adjusting a steering angle of the vehicle, a braking device that generates a braking force for the vehicle, and the like. The driving system control unit 7100 may have a function of a control device such as an Antilock Brake System (ABS), Electronic Stability Control (ESC), or the like.

A vehicle state detection unit 7110 is connected to the driving system control unit 7100. The vehicle state detection unit 7110 includes, for example, at least one of a gyro sensor that detects an angular velocity of an axial rotation motion of a vehicle body, an acceleration sensor that detects an acceleration of a vehicle, and sensors for detecting an amount of operation with respect to an accelerator pedal, an amount of operation with respect to a brake pedal, a steering angle of a steering wheel, an engine speed, a rotation speed of wheels, and the like. The driving system control unit 7100 performs arithmetic processing using a signal input from the vehicle state detection unit 7110 to control an internal combustion engine, a drive motor, an electric power steering device, a brake device, and the like.

The body system control unit 7200 controls operations of various devices equipped in the vehicle body in accordance with various programs. For example, the body system control unit 7200 functions as a control device of a keyless entry system, a smart key system, a power window device, or various lamps such as a head lamp, a back lamp, a brake lamp, a turn indicator, and a fog lamp. In this case, radio waves emitted from a portable device in place of a key or signals of various switches can be input to the body system control unit 7200. The body system control unit 7200 receives inputs of radio waves or signals and controls a door lock device, a power window device, and a lamp of the vehicle.

The battery control unit 7300 controls a secondary battery 7310 which is a power supply source of a driving motor in accordance with various programs. For example, information such as a battery temperature, a battery output voltage, or a remaining capacity of a battery is input from a battery device including the secondary battery 7310 to the battery control unit 7300. The battery control unit 7300 performs arithmetic processing using such a signal and performs temperature adjustment control of the secondary battery 7310 or control of a cooling device equipped in the battery device, and the like.

The vehicle external information detecting unit 7400 detects external information of a vehicle in which the vehicle control system 7000 is mounted. For example, at least one of the imaging unit 7410 and the vehicle external information detector 7420 is connected to the vehicle external information detecting unit 7400. In the imaging unit 7410, at least one of a Time of Flight (ToF) camera, a stereo camera, a single-lens camera, an infrared camera, and other cameras is included. The vehicle external information detector 7420 includes at least one of, for example, an environmental sensor detecting present weather or atmospheric phenomena and a surrounding information detection sensor detecting other vehicles, obstacles, pedestrians, and the like around a vehicle on which the vehicle control system 7000 is mounted.

An environment sensor, for example, may be at least one of a rain drop sensor detecting rain, a fog sensor detecting fog, a sunshine sensor detecting a degree of sunshine, and a snow sensor detecting a snowfall. The surroundings information detection sensor may be at least one of an ultrasonic sensor, a radar device, and a LIDAR (Light Detection and Ranging or Laser Imaging Detection and Ranging) device. The imaging unit 7410 and the vehicle external information detector 7420 may be included as independent sensors or devices or may be included as a device in which a plurality of sensors or devices are integrated.

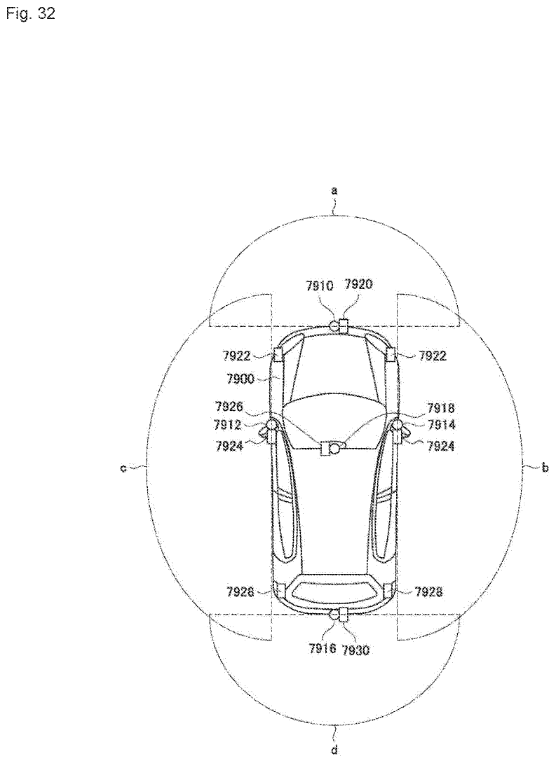

Here, FIG. 32 illustrates an example of installation positions of the imaging unit 7410 and the vehicle external information detector 7420. Imaging units 7910, 7912, 7914, 7916, and 7918 are provided, for example, at at least one of a front nose, side mirrors, a rear bumper, a back door, and an upper part of a windshield in a vehicle cabin of the vehicle 7900. The imaging unit 7910 included in the front nose and the imaging unit 7918 included in the upper part of the windshield in the vehicle cabin mainly acquire an image in front of the vehicle 7900. The imaging units 7912 and 7914 included in the side mirrors mainly acquire images of the sides of the vehicle 7900. The imaging unit 7916 included in the rear bumper or the back door mainly acquires an image of the rear of the vehicle 7900. The imaging unit 7918 included in the upper part of the windshield in the vehicle cabin is mainly used for detection of a preceding vehicle, a pedestrian, an obstacle, a traffic light, a traffic sign, a lane, or the like.

In FIG. 32, an example of imaging ranges of the respective imaging units 7910, 7912, 7914, and 7916 is illustrated. An imaging range a indicates an imaging range of the imaging unit 7910 provided on the front nose, imaging ranges b and c indicate imaging ranges of the imaging units 7912 and 7914 provided on the side mirrors, and an imaging range d indicates an imaging range of the imaging unit 7916 provided on the rear bumper or the back door. For example, a bird's-eye view image of the vehicle 7900 as viewed from above can be obtained when the image data captured by the imaging units 7910, 7912, 7914, and 7916 is superimposed.

Vehicle external information detecting units 7920, 7922, 7924, 7926, 7928, and 7930 provided in a front, a rear, a side, a corner, and an upper part of the windshield in the vehicle cabin of the vehicle 7900 may be, for example, ultrasonic sensors or radar devices. The vehicle external information detecting units 7920, 7926, and 7930 provided at the front nose, the rear bumper, the back door, and the upper part of the windshield in the vehicle cabin of the vehicle 7900 may be, for example, LIDAR devices. These vehicle external information detecting units 7920 to 7930 are mainly used for detection of a preceding vehicle, a pedestrian, an obstacle, or the like.

The description will be continued with reference to FIG. 31 again. The vehicle external information detecting unit 7400 causes the imaging unit 7410 to capture an image of the outside of the vehicle and receives the captured image data. Further, the vehicle external information detecting unit 7400 receives detection information from the connected vehicle external information detector 7420. When the vehicle external information detector 7420 is an ultrasonic sensor, a radar device, or a LIDAR device, the vehicle external information detecting unit 7400 transmits ultrasonic waves, electromagnetic waves, or the like, and receives information on received reflected waves. The vehicle external information detecting unit 7400 may perform object detection processing or distance detection processing for a person, a vehicle, an obstacle, a sign, a character on a road surface, or the like on the basis of the received information. The vehicle external information detecting unit 7400 may perform environment recognition processing for recognizing rainfall, fog, road surface situation, and the like on the basis of the received information. The vehicle external information detecting unit 7400 may calculate a distance to an object outside the vehicle on the basis of the received information.

Further, the vehicle external information detecting unit 7400 may perform image recognition processing or distance detection processing for recognizing a person, a vehicle, an obstacle, a sign, a character on a road surface, or the like on the basis of the received image data. The vehicle external information detecting unit 7400 may perform processing such as distortion correction or alignment on the received image data, and combine image data captured by the different imaging units 7410 to generate a bird's-eye view image or a panoramic image. The vehicle external information detecting unit 7400 may perform viewpoint conversion processing using the image data captured by the different imaging units 7410.

The vehicle internal information detecting unit 7500 detects information inside the vehicle. For example, a driver state detection unit 7510 that detects a driver's state is connected to the vehicle internal information detecting unit 7500. The driver state detection unit 7510 may include a camera that images a driver, a biological sensor that detects biological information of the driver, or a microphone that collects a sound in the vehicle cabin. The biological sensor is provided on, for example, a seat surface, a steering wheel, or the like and detects biological information of an occupant sitting on the seat or the driver holding the steering wheel. The vehicle internal information detecting unit 7500 may calculate the degree of fatigue or the degree of concentration of the driver or determine whether the driver is drowsing based on detected information input from the driver state detection unit 7510. The vehicle internal information detecting unit 7500 may perform a noise cancellation process or the like on a collected sound signal.

The integrated control unit 7600 controls overall operations of the inside of the vehicle control system 7000 in accordance with various programs. An input unit 7800 is connected to the integrated control unit 7600. For example, the input unit 7800 is realized by a device of which an input can be operated by an occupant such as a touch panel, a button, a microphone, a switch, a lever, or the like. Data acquired by performing speech recognition of speech input from a microphone may be input to the integrated control unit 7600. For example, the input unit 7800 may be a remote control device using infrared rays or other electric waves or may be an external connection device such as a mobile phone or a Personal Digital Assistant (PDA) that can respond to an operation of the vehicle control system 7000. The input unit 7800 may be, for example, a camera, and in this case, the occupant can input information by gesture. Alternatively, data obtained by detecting a motion of a wearable device worn by the occupant may be input. Further, the input unit 7800 may include, for example, an input control circuit that generates an input signal on the basis of information input by the occupant or the like using the input unit 7800 and outputs the input signal to the integrated control unit 7600. The occupant or the like inputs various types of data to the vehicle control system 7000 or instructs a processing operation by operating the input unit 7800.

The storage unit 7690 may include a read only memory (ROM) that stores various programs that are executed by the microcomputer and a random access memory (RAM) that stores various parameters, calculation results, sensor values, and the like. In addition, the storage unit 7690 may be realized by a magnetic storage device such as a hard disk drive (HDD), a semiconductor storage device, an optical storage device, a magneto-optical storage device, or the like.

The general-purpose communication I/F 7620 is a general-purpose communication I/F that mediates communication with various devices present in an external environment 7750. The general-purpose communication I/F 7620 may have implemented therein, a cellular communication protocol such as GSM (registered trademark) (Global System of Mobile communications), WiMAX (registered trademark), LTE (registered trademark) (Long Term Evolution), or LTE-A (LTE-Advanced), or other wireless communication protocols such as wireless LAN (also referred to as Wi-Fi (registered trademark)) or Bluetooth (registered trademark). The general-purpose communication I/F 7620, for example, may be connected to a device (for example, an application server or a control server) present on an external network (for example, the Internet, a cloud network, or a business-specific network) via a base station or an access point. In addition, for example, the general-purpose communication I/F 7620 may be connected to a terminal present near the vehicle (for example, a terminal of a driver, a pedestrian, or a store or a machine type communication (MTC) terminal) using a peer-to-peer (P2P) technology.

The dedicated communication I/F 7630 is a communication I/F supporting a communication protocol formulated for the purpose of use in a vehicle. The dedicated communication I/F 7630, for example, may implement a standard protocol such as a wireless access in vehicle environment (WAVE) that is a combination of IEEE802.11p of a lower layer and IEEE1609 of an upper layer, a dedicated short range communications (DSRC), or a cellular communication protocol. The dedicated communication I/F 7630, typically, performs V2X communication having a concept including one or more of vehicle to vehicle communication, vehicle to infrastructure communication, vehicle to home communication, and vehicle to pedestrian communication.

The positioning unit 7640 receives, for example, a GNSS signal from a global navigation satellite system (GNSS) satellite (for example, a GPS signal from a global positioning system (GPS) satellite), executes positioning, and generates position information including a latitude, longitude, and altitude of the vehicle. The positioning unit 7640 may specify a current position by exchanging signals with a wireless access point, or may acquire position information from a terminal such as a mobile phone, PHS, or smartphone having a positioning function.

The beacon reception unit 7650 receives radio waves or electromagnetic waves transmitted from a radio station or the like installed on a road, and acquires information such as a current position, traffic jam, no throughfare, or required time. A function of the beacon reception unit 7650 may be included in the above-described dedicated communication I/F 7630.

The in-vehicle device I/F 7660 is a communication interface that mediates connections between the microcomputer 7610 and various in-vehicle devices 7760 present in the vehicle. The in-vehicle device I/F 7660 may establish a wireless connection using a wireless communication protocol such as wireless LAN, Bluetooth (registered trademark), NFC (Near Field Communication), or WUSB (Wireless USB). Furthermore, the in-vehicle device I/F 7660 may establish a wired connection such as a USB (Universal Serial Bus), HDMI (registered trademark) (High-Definition Multimedia Interface), or MHL (Mobile High-definition Link) via a connection terminal (not illustrated) (and a cable if necessary). The in-vehicle device 7760 may include, for example, at least one of a mobile device or wearable device of an occupant and an information device carried in or attached to the vehicle. Further, the in-vehicle device 7760 may include a navigation device that searches for a route to an arbitrary destination. The in-vehicle device I/F 7660 exchanges control signals or data signals with the in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various programs on the basis of information acquired through at least one of the general-purpose communication I/F 7620, the dedicated communication I/F 7630, the positioning unit 7640, the beacon reception unit 7650, the in-vehicle device I/F 7660, and the vehicle-mounted network I/F 7680. For example, the microcomputer 7610 may calculate control target values for the driving force generation device, the steering mechanism, or the braking device based on the acquired information on the inside and outside of the vehicle and output control commands to the driving system control unit 7100. For example, the microcomputer 7610 may perform cooperative control for the purpose of implementing functions of an advanced driver assistance system (ADAS) including vehicle collision avoidance, impact mitigation, following traveling based on an inter-vehicle distance, vehicle speed maintenance driving, vehicle collision warning, vehicle lane deviation warning, and the like. The microcomputer 7610 may perform coordinated control to perform automated driving or the like in which a vehicle travels autonomously regardless of an operation of a driver by controlling a driving force generation device, a steering mechanism, or a braking device, or the like based on acquired surrounding information of the vehicle.

The microcomputer 7610 may generate 3-dimensional distance information between the vehicle and objects such as surrounding structures or people based on information acquired via at least one of the general-purpose communication I/F 7620, the dedicated communication I/F 7630, the positioning unit 7640, the beacon reception unit 7650, the in-vehicle device I/F 7660, and the vehicle-mounted network I/F 7680 and may generate local map information including surrounding information of a current position of the vehicle. The microcomputer 7610 may predict a danger such as collision of the vehicle, approach of a pedestrian, or entry into a traffic prohibition road based on the acquired information and may generate a warning signal. The warning signal may be, for example, a signal for generating a warning sound or turning on a warning lamp.

The audio/image output unit 7670 transmits an output signal of at least one of an audio and an image to an output device that is able to visually or audibly notify an occupant of the vehicle or the outside of the vehicle of information. In the example illustrated in FIG. 31, an audio speaker 7710, a display unit 7720, and an instrument panel 7730 are illustrated as output devices. For example, the display unit 7720 may include at least one of an in-vehicle display and a head-up display. The display unit 7720 may have an augmented reality (AR) display function. The output device may be not only such a device but also another device such as a headphone, a wearable device such as a glasses-type display worn by an occupant, a projector, or a lamp. When the output device is a display device, the display device visually displays results obtained through various processes performed by the microcomputer 7610 or information received from another control unit in various formats such as text, images, tables, and graphs. When the output device is a sound output device, the sound output device converts an audio signal formed by reproduced sound data, acoustic data, or the like into an analog signal and outputs the analog signal auditorily.

In the example illustrated in FIG. 31, at least two control units connected via the communication network 7010 may be integrated as one control unit.

Alternatively, each control unit may be configured of a plurality of control units. Further, the vehicle control system 7000 may include another control unit (not illustrated). Further, in the above description, the other control unit may have some or all of functions of any one of the control units. That is, predetermined calculation processing may be performed by any one of the control units as long as information is transmitted and received via the communication network 7010. Similarly, a sensor or device connected to any one of the control units may be connected to the other control unit, and a plurality of control units may transmit or receive detection information to and from each other via the communication network 7010.

The present technique can also take on the following configurations.

(1) A light detecting device including: an array unit configured to have a plurality of light reception areas and have a plurality of light receiving elements disposed inside each of the light reception areas; a calculation unit, for each pixel including one or more light receiving elements included in each of the plurality of light reception areas, configured to generate a histogram relating to the number of times of reception of light in the light receiving element inside the pixel and a light reception timing; and a malfunction detecting unit configured to detect a malfunction of the inside of the calculation unit.

(2) The light detecting device described in (1), in which the calculation unit includes: a sampling circuit configured to sample output signals of the plurality of light receiving elements included in each of the plurality of light reception areas with a predetermined sampling period and output detection signals indicating that the plurality of light receiving elements have received light for each pixel: an addition circuit configured to generate a pixel value acquired by adding the number of the detection signals for each pixel; and a histogram generating circuit configured to generate the histogram of each pixel in each of the plurality of light reception areas on the basis of the pixel value generated by the addition circuit, and the malfunction detecting unit detects a malfunction of at least one of the sampling circuit, the addition circuit, and the histogram generating circuit.

(3) The light detecting device described in (2), in which the calculation unit includes: a filter circuit configured to eliminate a noise component included in the histogram generated by the histogram generating circuit; an echo detecting circuit configured to measure a distance to an object by detecting a time difference until light is reflected by the object and is received by the array unit after the light is projected on the basis of the histogram after elimination of the noise component using the filter circuit, and the malfunction detecting unit detects a malfunction of at least one of the sampling circuit, the addition circuit, the histogram generating circuit, the filter circuit, and the echo detecting circuit.

(4) The light detecting device described in (3), in which the calculation unit includes a plurality of area calculation units corresponding to each of the plurality of light reception areas, each of the plurality of area calculation units includes at least some circuits among the sampling circuit, the addition circuit, the histogram generating circuit, the filter circuit, and the echo detecting circuit, and the malfunction detecting unit detects a malfunction of at least some circuits among the sampling circuit, the addition circuit, the histogram generating circuit, the filter circuit, and the echo detecting circuit for each of the plurality of area calculation units.

(5) The light detecting device described in (4), in which the malfunction detecting unit inputs the same test pattern signal to two area calculation units among the plurality of area calculation units and, in a case in which output signals of the two area calculation units are not the same, determines that any one of the two area calculation units has a malfunction.

(6) The light detecting device described in (5), in which the malfunction detecting unit includes: two selectors configured to select whether or not the test pattern signal is to be input to input nodes or internal nodes of the two area calculation units; and a comparator configured to compare output signals of the two area calculation units with each other when the two selectors select input of the test pattern signal.

(7) The light detecting device described in (6), in which the malfunction detecting unit includes two encoding units generating encoded data of output signals of the two area calculation units when the two selectors select input of the test pattern signal, and the comparator compares two pieces of the encoded data generated by the two encoding units.

(8) The light detecting device described in any one of (5) to (7), in which the calculation unit includes an even number, which is two or more, of the area calculation units, and the malfunction detecting unit divides the even number of the area calculation units into each set of two area calculation units, inputs the same test pattern signal to the two area calculation units of each set and, in a case in which output signals of the two area calculation units are not the same, determines that any one of the two area calculation units has a malfunction.

(9) The light detecting device described in any one of (5) to (7), in which the calculation unit includes an odd number, which is three or more, of the area calculation units, and the malfunction detecting unit divides the odd number of the area calculation units into a plurality of sets of two area calculation units using some of the area calculation units in a duplexing manner, inputs the same test pattern signal to the two area calculation units of each set and, in a case in which output signals of the two area calculation units are not the same, determines that any one of the two area calculation units has a malfunction.

(10) The light detecting device described in (4), in which the calculation unit includes three or more of the plurality of the area calculation units, the malfunction detecting unit inputs the same test pattern signal to the plurality of the area calculation units and, in accordance with whether output signals of some area calculation units among the plurality of the area calculation units are different from output signals of remaining area calculation units that are more than the some area calculation units, determines that the some area calculation units have a malfunction.

(11) The light detecting device described in (6) or (7), in which each of the plurality of the area calculation units has a plurality of stages of processing circuits, which are cascade-connected, including at least some circuits among the sampling circuit, the addition circuit, the histogram generating circuit, the filter circuit, and the echo detecting circuit, the comparator includes a plurality of comparison units connected to output nodes of the processing circuits of two or more stages that are cascade-connected to a later stage side of the selector for each of the plurality of the area calculation units, and each of the plurality of comparison units compares output signals of output nodes of the processing circuits of different stages in the two area calculation units with each other.

(12) The light detecting device described in (6) or (7), in which the calculation unit has processing circuits of a plurality of stages, which are cascade-connected, including some circuits among the sampling circuit, the addition circuit, the histogram generating circuit, the filter circuit, and the echo detecting circuit, and different selectors are connected to input sides of two or more processing circuits among the plurality of stages of processing circuits, and the test pattern signal is selectable using each of the selectors, and wherein the comparator is disposed in association with each of the selectors on a later stage side of the processing circuit to which each of the selectors is connected.

(13) The light detecting device described in (6) or (7), in which the number of pixels of the array unit is larger than the number of pixels for which the calculation unit performs generation of the histogram, the sampling circuit outputs the detection signal for each pixel of the array unit, the addition circuit generates the pixel value of each of pixels of which the number of pixels is smaller than the number of pixels of the array unit, and the selector is disposed between the sampling circuit and the addition circuit, inputs a detection signal output from the sampling circuit to the addition circuit with time adjustment at the time of a normal operation, and inputs the test pattern signal to the addition circuit at the time of a malfunction diagnosis.

(14) The light detecting device described in (6) or (7), in which the number of pixels of the array unit is larger than the number of pixels for which the calculation unit performs generation of the histogram, the sampling circuit outputs the detection signal for each pixel of the array unit, the addition circuit generates the pixel value of each of pixels of the array unit, and the histogram generating circuit generates the histogram of each of pixels of which the number of pixels is smaller than the number of pixels of the array unit, and the selector is disposed between the addition circuit and the histogram generating circuit, inputs the pixel value generated by the addition circuit to the histogram generating circuit with time adjustment at the time of a normal operation, and inputs the test pattern signal to the histogram generating circuit at the time of a malfunction diagnosis.

(15) The light detecting device described in (12), in which each of the plurality of area calculation units includes a calculation coefficient storing unit storing a first calculation coefficient used in a calculation process at the time of a normal operation and a second calculation coefficient used in a calculation process at the time of a malfunction diagnosis, the light detecting device further including a control unit configured to perform control of selecting one of the first calculation coefficient and the second calculation coefficient and supplying the selected calculation coefficient to the plurality of stages of processing circuits and perform selection switching of the selector.

(16) The light detecting device described in (12), in which each of the plurality of area calculation units has a first calculation coefficient storing unit storing a first calculation coefficient used in a calculation process at the time of a normal operation, the light detecting device further including: a second calculation coefficient storing unit configured to store a second calculation coefficient used in a calculation process at the time of a malfunction diagnosis: and a control unit configured to perform control of supplying the first calculation coefficient to the plurality of stages of processing circuits at the time of the normal operation, performs control of supplying the second calculation coefficient to the plurality of stages of processing circuits at the time of the malfunction diagnosis, and perform selection switching of the selector.

(17) The light detecting device described in any one of (5) to (16), further including a timing control unit configured to control the array unit and the calculation unit separately in a normal operation period in which the histogram is generated on the basis of light received by the array unit and in a malfunction diagnosis period in which malfunction detection of the calculation unit is performed on the basis of the test pattern signal in a state in which a light reception operation of the array unit is stopped.

(18) The light detecting device described in any one of (5) to (16), further including a timing control unit configured to perform control of inputting the test pattern signal to an input node or an internal node of the calculation unit and outputting a malfunction diagnosis signal from the calculation unit in a period in which each processing circuit inside the calculation unit performs processing on the basis of light received by the array unit.

(19) The light detecting device described in any one of (5) to (18), further including a pattern generator configured to generate the test pattern signal including a random pattern of a time series, wherein the same test pattern signal is supplied to the plurality of area calculation units.

(20) A distance measuring system including: the light detecting device described in any one of (3) to (19); and a light projection unit configured to project light to the object.

Aspects of the present disclosure are not limited to the aforementioned individual embodiments and include various modifications that those skilled in the art can achieve, and effects of the present disclosure are also not limited to the details described above. In other words, various additions, modifications, and partial deletion can be made without departing from the conceptual idea and the gist of the present disclosure that can be derived from the details defined in the claims and the equivalents thereof.

### REFERENCE SIGNS LIST

1 Distance measuring system
4 Malfunction detecting unit
5 Control unit
8 Selector
8-1 First selector
8-2 Second selector
9 Pattern generator
9-1 First pattern generator
9-2 Second pattern generator
10 Light detecting device
11 Control unit
13 Light emitting unit
14 Light receiving unit
15 Calculation unit
15-1 Area calculation unit
15-2 Area calculation unit
15-3 Area calculation unit
15-4 Area calculation unit
19 External output interface (I/F)
20 SPAD pixel
21 Light receiving element
21 Photodiode
22 Circuit
22A Circuit area
23 Quench resistor
24 Selection transistor
25 Digital converter
26 Inverter
27 Buffer
30 Macro pixel
31 Comparator
32 Encoding unit
33 Register block
34 Column shift number setting register
35 First register
36 Second register
37 Selector
38 Normal operation register
39 Selector
40 Malfunction diagnosis register block
41 Expected value output circuit
50 Depth image
80 Host
90 Object
100 Chip
101 Light receiving chip
102 Circuit chip
120 Effective pixel area
131 Light source
132 Collimator lens
133 Half mirror
134 Driving unit
135 Galvano mirror
141 SPAD array
142 Used SPAD array
143 Timing control circuit
144 Driving circuit
145 Output circuit
146 Light receiving lens
150 Sampling circuit
151 SPAD addition circuit
152 Histogram circuit
153 Filter circuit
154 Echo detecting circuit
155 Register block
251 Resistor
915 Calculation unit
916 Calculation coefficient

1. A light detecting device comprising:
an array unit configured to have a plurality of light reception areas and have a plurality of light receiving elements disposed inside each of the light reception areas;
a calculation unit, for each pixel including one or more light receiving elements included in each of the plurality of light reception areas, configured to generate a histogram relating to the number of times of reception of light in the light receiving element inside the pixel and a light reception timing; and
a malfunction detecting unit configured to detect a malfunction of the inside of the calculation unit.

2. The light detecting device according to claim 1,
wherein the calculation unit includes:
a sampling circuit configured to sample output signals of the plurality of light receiving elements included in each of the plurality of light reception areas with a predetermined sampling period and output detection signals indicating that the plurality of light receiving elements have received light for each pixel;
an addition circuit configured to generate a pixel value acquired by adding the number of the detection signals for each pixel;
a histogram generating circuit configured to generate the histogram of each pixel in each of the plurality of light reception areas on the basis of the pixel value generated by the addition circuit, and
wherein the malfunction detecting unit detects a malfunction of at least one of the sampling circuit, the addition circuit, and the histogram generating circuit.

3. The light detecting device according to claim 2,
wherein the calculation unit includes:
a filter circuit configured to eliminate a noise component included in the histogram generated by the histogram generating circuit; and
an echo detecting circuit configured to measure a distance to an object by detecting a time difference until light is reflected by the object and is received by the array unit after the light is projected on the basis of the histogram after elimination of the noise component using the filter circuit, and
wherein the malfunction detecting unit detects a malfunction of at least one of the sampling circuit, the addition circuit, the histogram generating circuit, the filter circuit, and the echo detecting circuit.

4. The light detecting device according to claim 3,
wherein the calculation unit includes a plurality of area calculation units corresponding to each of the plurality of light reception areas,
wherein each of the plurality of area calculation units includes at least some circuits among the sampling circuit, the addition circuit, the histogram generating circuit, the filter circuit, and the echo detecting circuit, and
wherein the malfunction detecting unit detects a malfunction of at least some circuits among the sampling circuit, the addition circuit, the histogram generating circuit, the filter circuit, and the echo detecting circuit for each of the plurality of area calculation units.

5. The light detecting device according to claim 4, wherein the malfunction detecting unit inputs the same test pattern signal to two area calculation units among the plurality of area calculation units and, in a case in which output signals of the two area calculation units are not the same, determines that any one of the two area calculation units has a malfunction.

6. The light detecting device according to claim 5, wherein the malfunction detecting unit includes:
two selectors configured to select whether or not the test pattern signal is to be input to input nodes or internal nodes of the two area calculation units; and
a comparator configured to compare output signals of the two area calculation units with each other when the two selectors select input of the test pattern signal.

7. The light detecting device according to claim 6,
wherein the malfunction detecting unit includes two encoding units generating encoded data of output signals of the two area calculation units when the two selectors select input of the test pattern signal, and
wherein the comparator compares two pieces of the encoded data generated by the two encoding units.

8. The light detecting device according to claim 5,
wherein the calculation unit includes an even number, which is two or more, of the area calculation units, and
wherein the malfunction detecting unit divides the even number of the area calculation units into each set of two area calculation units, inputs the same test pattern signal to the two area calculation units of each set and, in a case in which output signals of the two area calculation units are not the same, determines that any one of the two area calculation units has a malfunction.

9. The light detecting device according to claim 5,
wherein the calculation unit includes an odd number, which is three or more, of the area calculation units, and
wherein the malfunction detecting unit divides the odd number of the area calculation units into a plurality of sets of two area calculation units using some of the area calculation units in a duplexing manner, inputs the same test pattern signal to the two area calculation units of each set and, in a case in which output signals of the two area calculation units are not the same, determines that any one of the two area calculation units has a malfunction.

10. The light detecting device according to claim 4,
wherein the calculation unit includes three or more of the plurality of area calculation units, and
wherein the malfunction detecting unit inputs the same test pattern signal to the plurality of the area calculation units and, in accordance with whether output signals of some area calculation units among the plurality of the area calculation units are different from output signals of remaining area calculation units that are more than the some area calculation units, determines that the some area calculation units have a malfunction.

11. The light detecting device according to claim 6,
wherein each of the plurality of the area calculation units has a plurality of stages of processing circuits, which are cascade-connected, including at least some circuits among the sampling circuit, the addition circuit, the histogram generating circuit, the filter circuit, and the echo detecting circuit,
wherein the comparator includes a plurality of comparison units connected to output nodes of the processing circuits of two or more stages that are cascade-connected to a later stage side of the selector for each of the plurality of the area calculation units, and
wherein each of the plurality of comparison units compares output signals of output nodes of the processing circuits of different stages in the two area calculation units with each other.

12. The light detecting device according to claim 6,
wherein the calculation unit has processing circuits of a plurality of stages, which are cascade-connected, including some circuits among the sampling circuit, the addition circuit, the histogram generating circuit, the filter circuit, and the echo detecting circuit,
wherein different selectors are connected to input sides of two or more processing circuits among the plurality of stages of processing circuits, and the test pattern signal is selectable using each of the selectors, and
wherein the comparator is disposed in association with each of the selectors on a later stage side of the processing circuit to which each of the selectors is connected.

13. The light detecting device according to claim 6,
wherein the number of pixels of the array unit is larger than the number of pixels for which the calculation unit performs generation of the histogram, wherein the sampling circuit outputs the detection signal for each pixel of the array unit,
wherein the addition circuit generates the pixel value of each of pixels of which the number of pixels is smaller than the number of pixels of the array unit, and wherein the selector is disposed between the sampling circuit and the addition circuit, inputs a detection signal output from the sampling circuit to the addition circuit with time adjustment at the time of a normal operation, and inputs the test pattern signal to the addition circuit at the time of a malfunction diagnosis.

14. The light detecting device according to claim 6,
wherein the number of pixels of the array unit is larger than the number of pixels for which the calculation unit performs generation of the histogram,
wherein the sampling circuit outputs the detection signal for each pixel of the array unit,
wherein the addition circuit generates the pixel value of each of pixels of the array unit,
wherein the histogram generating circuit generates the histogram of each of pixels of which the number of pixels is smaller than the number of pixels of the array unit, and
wherein the selector is disposed between the addition circuit and the histogram generating circuit, inputs the pixel value generated by the addition circuit to the histogram generating circuit with time adjustment at the time of a normal operation, and inputs the test pattern signal to the histogram generating circuit at the time of a malfunction diagnosis.

15. The light detecting device according to claim 12,
wherein each of the plurality of area calculation units includes a calculation coefficient storing unit storing a first calculation coefficient used in a calculation process at the time of a normal operation and a second calculation coefficient used in a calculation process at the time of a malfunction diagnosis,
the light detecting device further comprising a control unit configured to perform control of selecting one of the first calculation coefficient and the second calculation coefficient and supplying the selected calculation coefficient to the plurality of stages of processing circuits and perform selection switching of the selector.

16. The light detecting device according to claim 12,
wherein each of the plurality of area calculation units has a first calculation coefficient storing unit storing a first calculation coefficient used in a calculation process at the time of a normal operation,
the light detecting device further comprising:
a second calculation coefficient storing unit configured to store a second calculation coefficient used in a calculation process at the time of a malfunction diagnosis; and
a control unit configured to perform control of supplying the first calculation coefficient to the plurality of stages of processing circuits at the time of the normal operation, perform control of supplying the second calculation coefficient to the plurality of stages of processing circuits at the time of the malfunction diagnosis, and perform selection switching of the selector.

17. The light detecting device according to claim 5, further comprising a timing control unit configured to control the array unit and the calculation unit separately in a normal operation period in which the histogram is generated on the basis of light received by the array unit and in a malfunction diagnosis period in which malfunction detection of the calculation unit is performed on the basis of the test pattern signal in a state in which a light reception operation of the array unit is stopped.

18. The light detecting device according to claim 5, further comprising a timing control unit configured to perform control of inputting the test pattern signal to an input node or an internal node of the calculation unit and outputting a malfunction diagnosis signal from the calculation unit in a period in which each processing circuit inside the calculation unit performs processing on the basis of light received by the array unit.

19. The light detecting device according to claim 5, further comprising a pattern generator configured to generate the test pattern signal including a random pattern of a time series,
wherein the same test pattern signal is supplied to the plurality of area calculation units.

20. A distance measuring system comprising:
the light detecting device according to claim 3; and
a light projection unit configured to project light to the object.
